(19) United States
(12) Patent Application Publication
(10) Pub. No.: US 2020/0122678 A1
(43) Pub. Date: Apr. 23, 2020

(54) OCCUPANT PROTECTION DEVICE

(71) Applicant: TOYODA GOSEI CO., LTD., Kiyosu-shi (JP)

(72) Inventors: Motoyuki TANAKA, Kiyosu-shi (JP); Hajime KITTE, Kiyosu-shi (JP); Kenichi FUKURONO, Kiyosu-shi (JP); Yuji SATO, Kiyosu-shi (JP)

(21) Appl. No.: 16/655,761

(22) Filed: Oct. 17, 2019

(30) Foreign Application Priority Data
Oct. 19, 2018 (JP) 2018-197652
Mar. 27, 2019 (JP) 2019-060029
Sep. 25, 2019 (JP) 2019-174682

(51) Int. Cl. B60R 21/2338; B60R 21/231; B60R 21/205; B60R 21/015; B60R 21/0132

(52) U.S. Cl. CPC B60R 21/2338; B60R 21/231; B60R 21/205; B60R 2021/0048; B60R 21/0132; B60R 2021/23386; B60R 21/01512

(57) ABSTRACT

An occupant protection device includes: an airbag which is deployed and inflated rearward from an accommodation part so that the airbag receives the occupant when inflation gas flows in, the airbag having an inflation completion shape of a loop shape including an upper and lower portions which branch up and down from an inflow opening side and a rear portion which is a mutual connecting part between rear ends of the upper portion and the lower portion as a confluence part on a tip end side. The airbag includes: a bag main body including the upper portion, the lower portion, and the rear portion; and a connecting member having flexibility which is disposed between the upper portion and the lower portion and connects the upper portion and the lower portion so as to regulate a separation distance between the upper portion and the lower portion when inflation is completed.

### CROSS-REFERENCE TO RELATED APPLICATION(S)

This application is based upon and claims the benefit of priority from prior Japanese patent applications No. 2018-197652 filed on Oct. 19, 2018, No. 2019-060029 filed on Mar. 27, 2019, and No. 2019-174682 filed on Sep. 25, 2019, the entire contents of which are incorporated herein by reference.

### BACKGROUND

### 1. Field of the Invention

The present invention relates to an occupant protection device provided with a loop-shaped airbag which protrudes rearward from an accommodation part on a front side of a seated occupant when inflation gas flows in and inflates to be able to receive the occupant moving forward.

### 2. Description of the Related Art

In the related art, as an occupant protection device, devices where airbags which protect the seated occupant can complete the inflation quickly and the inflation can be completed in a loop shape so as to suppress an increase in reaction force when receiving the occupant have been known (see JP-A-1994-344844 and JP-A-2017-222331, for example). These airbags have a loop shape which has a hollow portion into which inflation gas does not flow in a middle part in a front-rear direction when inflating is completed and the volume of the inflating part is small. Therefore, inflation can be completed quickly, and when receiving the occupant, the hollow portion disposed in the middle part in the front-rear direction is crushed to suppress the increase in reaction force, so that the airbag can receive and protect the occupant.

However, in any occupant protection devices, the airbag at the time of completion of inflation is configured to be easily crushed forward by providing a hollow portion in the middle part in the front-rear direction. Therefore, on the contrary, there is a possibility that a stable reaction force cannot be secured when receiving an occupant.

### SUMMARY

The present invention has been made to solve the problem described above, and an object thereof is to provide an occupant protection device where an airbag can complete inflation quickly and which can secure a stable reaction force when receiving an occupant.

According to an aspect of the invention, there is provided an occupant protection device including: an airbag which is folded and accommodated on a front side of a seated occupant in a vehicle and which is deployed and inflated rearward from an accommodation part so that the airbag receives the occupant when inflation gas flows in, the airbag having an inflow opening through which the inflation gas flows in, being disposed so that a peripheral edge of the inflow opening is fixed to the accommodation part, and having an inflation completion shape of a loop shape including an upper portion and a lower portion which branch up and down from the inflow opening side and a rear portion which is a mutual connecting part between rear ends of the upper portion and the lower portion as a confluence part on a tip end side, wherein: the airbag includes: a bag main body including the upper portion, the lower portion, and the rear portion; and a connecting member having flexibility which is disposed between the upper portion and the lower portion and connects the upper portion and the lower portion so as to regulate a separation distance between the upper portion and the lower portion when inflation is completed.

In the occupant protection device according to the invention, when the bag main body of the airbag completes the inflation and receives the occupant, the rear portion receives the occupant. In this case, the rear portion moves forward and causes the upper portion and the lower portion to expand. However, since the upper portion and the lower portion are connected by the connecting member having flexibility and the separation distance between the upper portion and the lower portion is not increased, the forward movement of the rear portion is restricted. Therefore, the reaction force of the bag main body is secured, and thus the occupant can be accurately received. In addition, since the bag main body is merely provided with the connecting member between the upper portion and the lower portion on the front side of the rear portion and does not have an inflating part, the volume thereof can be reduced. Thus, when the inflation gas flows in, the inflation can be completed quickly.

Therefore, in the occupant protection device according to the invention, the airbag can quickly complete the inflation, and further the airbag after the completion of inflation can secure a stable reaction force when receiving the occupant.

According to another aspect of the invention, the connecting member may be disposed so that the separation distance between the upper portion and the lower portion is adjusted to at least two long and short types of a first distance and a second distance longer than the first distance.

In such a configuration, when the bag main body receives the occupant by the rear portion, if the separation distance between the upper portion and the lower portion is set to the first distance, the reaction force can be increased and the occupant can be received, and thus the occupant which moves forward with high kinetic energy can be accurately received. However, when the reaction force becomes extremely large, if the connecting member can increase the separation distance between the upper portion and the lower portion from the first distance to the second distance, an increase in the reaction force can be suppressed and the occupant received by the bag main body can be suitably protected.

The adjustment of the second distance of the connecting member in this case can be exemplified by an adjustment in which the distance is set to be larger than the first distance in a state where the connecting member releases the connection between the upper portion and the lower portion or maintains the connection state between the upper portion and the lower portion.

According to a still another aspect of the invention, the connecting member may be connected to a length adjusting unit which adjusts the separation distance between the upper portion and the lower portion to the first distance and the second distance longer than the first distance, adjustment of the first distance and the second distance in the length adjusting unit may be controlled by a control device; and based on a signal from an occupant detecting unit which detects whether an occupant to be received by the bag main body is a large size occupant or a small size occupant, when the occupant to be received is detected as a large size occupant, the control device may adjust the length adjusting unit so that the separation distance between the upper portion and the lower portion becomes the first distance, and when the occupant to be received is detected as a small size occupant, the control device may adjust the length adjusting unit so that the separation distance between the upper portion and the lower portion becomes the second distance.

In such a configuration, when the bag main body at the completion of inflation receives the large size occupant, the control device adjusts the length adjusting unit so that the separation distance between the upper portion and the lower portion becomes the first distance, and thus the reaction force is increased and it is possible to accurately receive the large size occupant with high kinetic energy. On the other hand, when the bag main body at the completion of inflation receives the small size occupant, the control device adjusts the length adjusting unit so that the separation distance between the upper portion and the lower portion becomes the second distance, and thus the reaction force is reduced and it is possible to suitably receive the small size occupant with low kinetic energy.

According to a still another aspect of the invention, the occupant protection device may further including: a seat belt device which is provided with a pretensioner mechanism and a force limiter mechanism for restraining an occupant seated on a seat, the seat belt device adjusting a tensile force of a belt which restrains the occupant in at least two low and high stages during operation, wherein: the control device controls an operation of an inflator which supplies inflation gas to the airbag at the time of a vehicle collision, controls adjustment of the length adjusting unit during operation and adjustment of a tensile force of the seat belt device, and is configured to detect whether a speed of the vehicle is a high speed or a low or moderate speed; and when the control device controls the inflator to operate, when the occupant seated on the seat is detected as a large size occupant by the occupant detecting unit, the length adjusting unit is adjusted so that the separation distance between the upper portion and the lower portion becomes the first distance, and further at the speed of the vehicle, when it is detected as a high speed, the tensile force of the belt is adjusted to a high tensile force, and when it is detected as a low or moderate speed, the tensile force of the belt is adjusted to a low tensile force, or when the occupant seated on the seat is detected as a small size occupant by the occupant detecting unit, the length adjusting unit is adjusted so that the separation distance between the upper portion and the lower portion becomes the second distance, and further at the speed of the vehicle, when it is detected as a high speed, the tensile force of the belt is adjusted to a high tensile force, and when it is detected as a low or moderate speed, the tensile force of the belt is adjusted to a low tensile force.

In such a configuration, when a vehicle collision occurs, if the seated occupant is a large size occupant, the control device operates the inflator to inflate the airbag, detects that the seated occupant is a large size occupant from the occupant detecting unit, and adjusts the length adjusting unit so that the separation distance between the upper portion and the lower portion becomes the first distance. Therefore, the bag main body that has completed the inflation can increase the reaction force and accurately receive the large size occupant with high kinetic energy. Further, in this case, when the vehicle collides at a high speed, the control device makes the belt hung on the occupant pulled by increasing the tensile force of the belt of the seat belt device, in such a manner that the forward movement of the large size occupant with high kinetic energy can be accurately suppressed. Further, when the speed of the vehicle at the collision is a low or moderate speed, the control device makes the belt hung on the occupant pulled by decreasing the tensile force of the belt of the seat belt device, in such a manner that the forward movement of the large size occupant having relatively low kinetic energy can be accurately suppressed.

Further, at the time of the vehicle collision, if the seated occupant is a small size occupant, the control device operates the inflator to inflate the airbag, detects that the seated occupant is a small size occupant from the occupant detecting unit, and adjusts the length adjusting unit so that the separation distance between the upper portion and the lower portion becomes the second distance. Therefore, the bag main body that has completed the inflation can reduce the reaction force and accurately receive the small size occupant with low kinetic energy. Further, in this case, when the vehicle collides at a high speed, the control device makes the belt hung on the occupant pulled by increasing the tensile force of the belt of the seat belt device, in such a manner that the forward movement of the small size occupant with high kinetic energy can be accurately suppressed. Further, when the speed of the vehicle at the collision is a low or moderate speed, the control device makes the belt hung on the occupant pulled by decreasing the tensile force of the belt of the seat belt device, in such a manner that the forward movement of the small size occupant having relatively low kinetic energy can be accurately suppressed.

That is, in the occupant protection device described above, it is possible to accurately protect an occupant according to the physique of the occupant and the vehicle speed.

According to a sill another aspect of the invention, there is provided an occupant protection device including: an airbag having a loop shape which is accommodated in an accommodation part disposed in a vehicle body side part on a front side of a seated occupant, protrudes rearward from the accommodation part when inflation gas flows in, is inflated to receive the occupant moving forward, and is provided with a hollow portion in which inflation gas does not flow in a vicinity of a center of an inflating part, wherein: as the shape at the time of completion of inflation, the airbag has a substantially triangular annular shape in which a first inflating portion extending in a substantially columnar shape from the accommodation part so as to extend along the vehicle body side part and supported by the vehicle body side part, a second inflating portion extending in a substantially columnar shape from an end portion in an up-down direction of the first inflating portion to a rear side on a protection target part side of the occupant, and a third inflating portion which extends from a rear end of the second inflating portion and intersects the other end portion in the up-down direction of the first inflating portion are disposed so as to surround the hollow portion; when the inflation is completed, in the airbag, a vicinity of the rear end of the second inflating portion is disposed at the rearmost end to serve as a receiving part for a protection target part of the occupant moving forward; and when the protection target part of the occupant is received in the vicinity of the rear end of the second inflating portion, a vicinity of the rear end of the second inflating portion is supported by the third inflating portion so as to allow the second inflating portion to perform compression deformation where the rear end side approaches a front end side along an axial direction of a substantially columnar shape of the inflation completion shape and a vicinity of the front end of the second inflating portion is connected to the first inflating portion so as to ensure a reaction force from the vehicle body side part.

In the occupant protection device according to the invention, when the airbag completes the inflation, the vicinity of the rear end of the second inflating portion is used as the receiving part of the protection target part of the occupant, and when the occupant moves forward, the protection target part of the occupant is received in the vicinity of the rear end of the second inflating portion as the receiving part. In this case, in the second inflating portion, the third inflating portion supports the vicinity of the rear end of the second inflating portion so as to be able to perform compression deformation where the rear end side can approach the front end side along the axial direction of the substantially columnar shape of the inflation completion shape, and further, the vicinity of the front end of the second inflating portion is connected to the first inflating portion so as to be able to ensure a reaction force from the vehicle body side part. Therefore, as a buckling deformation state, in other words, as a compression deformation state (a state where the second inflating portion is compressed in the length dimension in the front-rear direction) in which the rear end side approaches the front end side along the axial direction of the substantially columnar shape of the inflation completion shape, the second inflating portion behaves to receive the protection target part of the occupant. That is, since the airbag which completes the inflation is deformed with compression deformation such as buckling deformation of the second inflating portion that can ensure a high reaction force, not bending deformation, it is possible to stably secure a reaction force above a predetermined level and receive the protection target part of the occupant. Needless to say, since the airbag is provided with a hollow portion, it has less capacity to flow the inflation gas compared to a case where the entire outer shape of the airbag is used as an inflated portion, and thus the inflation can be completed quickly.

Therefore, in the occupant protection device according to the invention, the airbag can quickly complete the inflation and a stable reaction force can be secured when the occupant is received.

According to a still another aspect of the invention, the second inflating portion of the airbag may be disposed so that a direction extending from the front end to the rear end when the inflation is completed is set to a direction along a direction opposite to a movement direction of the protection target part of the occupant moving forward when the occupant protection device is operated.

In such a configuration, the second inflating portion of the airbag extends from the front end to the rear end when the inflation is completed along a direction along the direction opposite to the movement direction of the protection target part of the occupant moving forward when the occupant protection device is operated, and when the protection target part of the occupant is received and it becomes a state of buckling deformation, a more stable reaction force can be secured more accurately.

In the occupant protection device according to the invention, as the protection target part of the occupant which is received in the vicinity of the rear end of the second inflating portion of the airbag, the knee and head of the occupant can be exemplified. For example, as an occupant protection device when the knee of the occupant is the protection target part, the accommodation part of the airbag is disposed on the rear surface side of the vehicle body side part on the front side of the lower limb of a seated occupant, and when the airbag is inflated, the airbag is configured to protrude rearward from the accommodation part and be inflated so as to be able to receive the occupant moving forward. Further, the first inflating portion at the time of completion of inflation is disposed so as to extend along the rear surface side of the vehicle body side part and to be supported by the rear surface side of the vehicle body side part and the second inflating portion at the time of completion of inflation extends rearward from a vicinity of the upper end of the first inflating portion, and further a vicinity of the rear end may be disposed as a receiving part for receiving the knee of the occupant moving forward.

In addition, as an occupant protection device when the head of an occupant of a rear seat is the protection target part, the accommodation part for the airbag is disposed on a rear surface side of a front seat as the vehicle body side part on the front side of the seated occupant and when the airbag is inflated, the airbag is configured to protrude rearward from the accommodation part and be inflated so as to be able to receive the occupant moving forward. Further, the first inflating portion at the time of completion of inflation is disposed so as to extend along a rear surface side of the front seat as the vehicle body side part and to be supported by the rear surface side of the front seat. In addition, the second inflating portion at the time of completion of inflation extends rearward from a vicinity of the upper end of the first inflating portion and a vicinity of the rear end is disposed as a receiving part for receiving the head of the occupant moving forward.

Also, as an occupant protection device when the head of an occupant of a passenger seat is the protection target part, the accommodation part for the airbag is disposed on a rear surface side of an instrument panel as a vehicle body side part on the front side of a seated occupant and when the airbag is inflated, the airbag is configured to protrude rearward from the accommodation part so as to block between the instrument panel and a windshield above the instrument panel and be inflated to be able to receive the occupant moving forward. Further, the first inflating portion at the time of completion of inflation is disposed to extend rearward and downward from the accommodation part so as to extend along an upper surface of the instrument panel as the vehicle body side part and to be supported by the instrument panel and the second inflating portion at the time of completion of inflation extends obliquely upward and rearward from a vicinity of the front end of the first inflating portion and a vicinity of the rear end may be disposed as a receiving part for receiving a head of the occupant moving forward.

According to a still another aspect of the invention, when inflation is completed in a state of being mounted on a vehicle, the airbag may be configured so that a length dimension in a front-rear direction from a front end part intersecting the first inflating portion to a rear end part intersecting the third inflating portion in the second inflating portion in a state of protruding from the accommodation part is set to be shorter than the sum of a length dimension from a part of the first inflating portion, which is the part intersects the second inflating portion, to a part of the first inflating portion, which is the part intersects the third inflating portion and a length dimension from an upper end part intersecting the second inflating portion to a lower end part intersecting the first inflating portion in the third inflating portion, and is set to be longer than the length dimension from the part of the first inflating portion, which is the part intersects the second inflating portion, to the part of the first inflating portion, which is the part intersects the third inflating portion.

In such a configuration, when the airbag is inflated, the first inflating portion, the second inflating portion, and the third inflating portion have substantially columnar shapes and complete the inflation in a substantially triangular annular shape. In this case, the first inflating portion has a length dimension shorter than that of the second inflating portion extending in the front-rear direction and is inflated rearward and downward along the upper surface side of the instrument panel. Although the length dimension of the second inflating portion is longer than that of the first inflating portion, it is smaller than the sum of the length dimensions of the first inflating portion and the third inflating portion. Therefore, the third inflating portion can stably secure a shape (that is, the shape in which the upper end part is disposed behind the lower end part) in which the lower end part is disposed in front of the upper end part. As a result, a vicinity of the rear end of the second inflating portion at the time of completion of inflation becomes the rearmost end of the airbag and the head of the occupant of the passenger seat moving forward can be suitably received.

According to a still another aspect of the invention, the airbag may be provided with a front-rear tether which connects the third inflating portion and the accommodation part side at the time of completion of inflation and restricts a rearward movement of the third inflating portion away from the accommodation part.

In such a configuration, the third inflating portion disposed substantially vertically between the first inflating portion and the second inflating portion is restricted from entire or partial rearward movement by the front-rear tether. Therefore, when the inflation is completed, the substantially triangular annular shape of the airbag becomes stable, which can contribute to stabilizing the occupant protection performance of the airbag.

According to a still another aspect of the invention, the airbag may be provided with an upper-lower tether which connects the second inflating portion and the first inflating portion at the time of completion of inflation and restricts a movement of the second inflating portion and the first inflating portion in a direction of mutual separation.

In such a configuration, the upper-lower tether can stabilize the separation state between the second inflating portion and the first inflating portion when the airbag is completely inflated, and this can contribute to stabilizing the occupant protection performance of the airbag by stabilizing the substantially triangular annular shape of the airbag at the time of completion of inflation.

According to a still another aspect of the invention, the airbag may be provided with an upper-outer tether which connects an upper surface side of the second inflating portion at the time of completion of inflation and the accommodation part side and restricts a downward movement of the second inflating portion away from the windshield.

In such a configuration, the airbag at the time of completion of inflation can maintain the state in which the upper surface side of the second inflating portion is in contact with the windshield by the upper outer tether. Therefore, at the time of occupant restraint including the initial restraint, the second inflating portion is supported by the windshield on the upper surface side, and thus the behavior of the buckling deformation state can be stabilized by suppressing the behavior of bending deformation. Therefore, the airbag can exhibit favorable occupant restraint performance that can secure a stable reaction force.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a schematic side view illustrating an operating state of an occupant protection device according to a first embodiment of the invention;

FIG. 2 is a schematic longitudinal cross-sectional view of an airbag during operation of the occupant protection device according to the first embodiment, illustrating the II-II portion of FIG. 1;

FIG. 3 is a plan view illustrating constituent materials of the airbag according to the first embodiment;

FIG. 4 is a schematic side view of the airbag of the occupant protection device according to the first embodiment in a state where a separation distance between an upper portion and a lower portion of a bag main body is a second distance;

FIG. 5 is a view illustrating an operating state of an occupant protection device according to a second embodiment and is a schematic side view when an occupant is a large size occupant;

FIG. 6 is a view illustrating an operating state of the occupant protection device according to the second embodiment and is a schematic side view when the occupant is a small size occupant;

FIG. 7 is a plan view illustrating constituent materials of an airbag according to the second embodiment;

FIGS. 8A and 8B are views illustrating a state in which a connecting member maintains a separation distance between an upper portion and a lower portion at a first distance and a state in which the connecting member maintains the separation distance between the upper portion and the lower portion at a second distance by adjustment of a length adjusting unit according to the second embodiment;

FIG. 9 is a table illustrating a state in which a control device of the occupant protection device according to the second embodiment adjusts the length adjusting unit of the connecting member and a seat belt device according to a physique of an occupant and a vehicle speed;

FIG. 10 is a view illustrating an operating state of an occupant protection device according to a third embodiment and is a schematic side view when an occupant is a large size occupant;

FIG. 11 is a view illustrating an operating state of the occupant protection device according to the third embodiment and is a schematic side view when the occupant is a small size occupant; and

FIGS. 12A and 12B are views illustrating a state in which a connecting member maintains a separation distance between an upper portion and a lower portion at a first distance and a state in which the connecting member maintains the separation distance between the upper portion and the lower portion at a second distance by adjustment of a length adjusting unit according to the third embodiment.

FIG. 13 is a schematic side view illustrating an operating state of an occupant protection device according to a fourth embodiment of the invention;

FIG. 14 is a schematic longitudinal cross-sectional view of an airbag during operation of the occupant protection device according to the fourth embodiment;

FIG. 15 is a schematic longitudinal cross-sectional view of the airbag during operation of the occupant protection device according to the fourth embodiment;

FIG. 16 is a schematic longitudinal cross-sectional view of the airbag during operation of the occupant protection device according to the fourth embodiment, and illustrates the IV-IV part of FIG. 14;

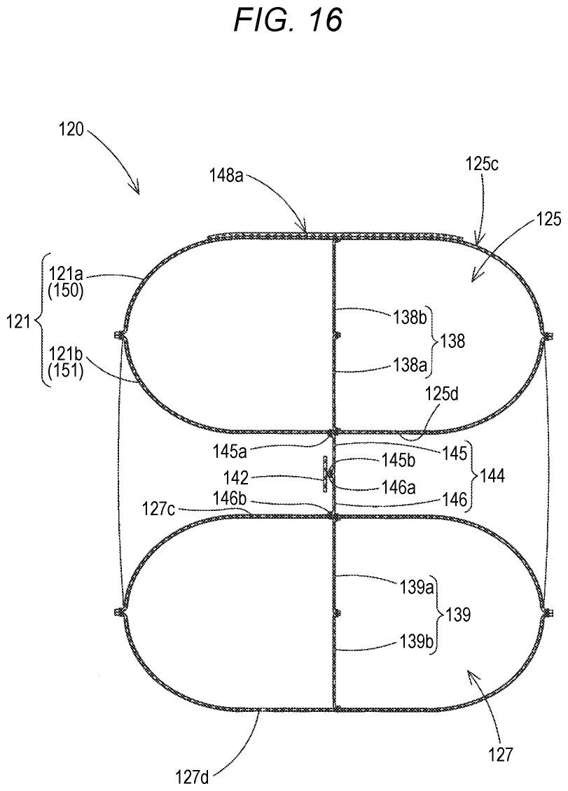

FIG. 17 is a schematic perspective view at the time of completion of inflation of the single airbag according to the fourth embodiment;

FIG. 18 is a plan view illustrating constituent materials of the airbag according to the fourth embodiment;

FIG. 19 is a plan view illustrating a combined state of various tethers of the airbag according to the fourth embodiment;

FIGS. 20A and 20B are views for sequentially explaining an inflated state of the airbag when the occupant protection device according to the fourth embodiment is operated; and

FIGS. 21A and 21B are views for sequentially explaining the inflated state of the airbag when the occupant protection device according to the fourth embodiment is operated and illustrate a state after FIGS. 20A and 20B;

FIG. 22 is a schematic side view illustrating an operating state of an occupant protection device according to a fifth embodiment of the invention;

FIG. 23 is a schematic longitudinal cross-sectional view of the airbag during operation of the occupant protection device according to the fifth embodiment, and illustrates the XI-XI part of FIG. 22;

FIG. 24 is a schematic side view illustrating an operating state of an occupant protection device according to a sixth embodiment of the invention;

FIG. 25 is a schematic longitudinal cross-sectional view of the airbag during operation of the occupant protection device according to the sixth embodiment, and illustrates the XIII-XIII part of FIG. 24; and

FIG. 26 is a schematic side view illustrating an operating state of an occupant protection device according to a seventh embodiment of the invention;

### DETAILED DESCRIPTION OF THE INVENTION

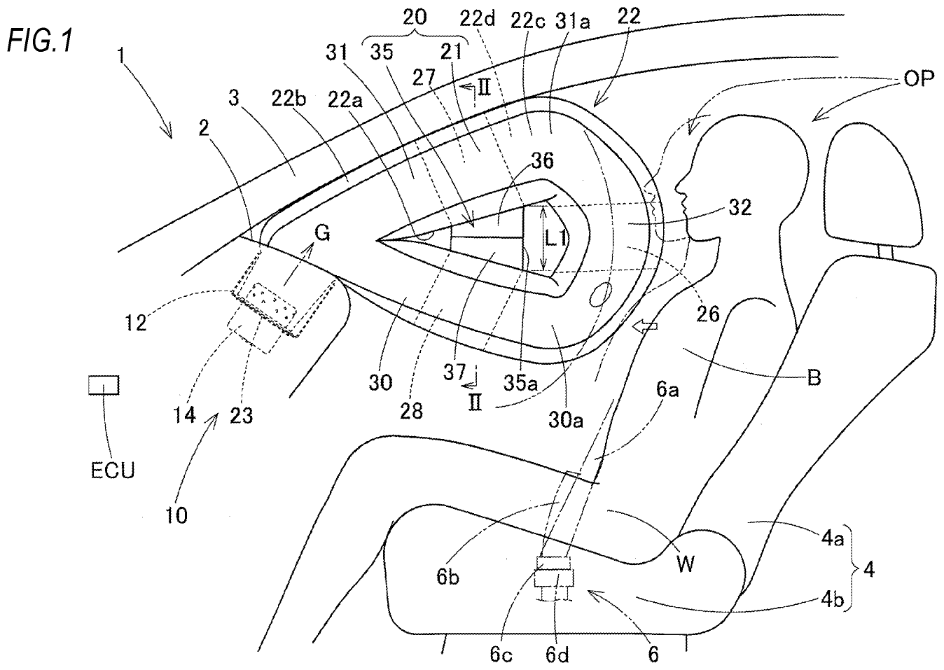

Hereinafter, an embodiment of the invention will be described with reference to the drawings. As illustrated in FIG. 1, an occupant protection device 10 according to a first embodiment is mounted on a vehicle body side portion in front of a passenger seat on a front seat side of a vehicle 1, that is, on a portion of an instrument panel 2.

A seat 4 of the passenger seat includes a backrest portion 4a and a seat portion 4b. An occupant OP seated in the seat 4 is usually seated by wearing belts 6a and 6b of a seat belt device 6. The shoulder belt 6a extending from a tongue plate 6c for assembling to a buckle 6d is disposed in front of a chest B of the occupant OP and the lap belt 6b extending from the tongue plate 6c is disposed in front of a waist W.

The occupant protection device 10 includes an airbag 20 and an inflator 14 which supplies an inflation gas G to the airbag 20. The airbag 20 is folded and accommodated in a case 12 as an accommodation part and the inflator 14 is attached to the case 12 so that the inflation gas can be supplied to the folded airbag 20. The case 12 is mounted and fixed to a vehicle body side member (not illustrated) on an upper surface side of the instrument panel 2. When the airbag 20 is inflated, the airbag 20 pushes open an airbag cover (not illustrated) provided on the instrument panel 2 and is deployed and inflated rearward as illustrated in FIG. 1.

The operation of the inflator 14 in the occupant protection device 10 is controlled by a control device ECU. When the control device ECU receives a signal from a collision detection sensor (not illustrated) disposed in a front bumper or the like which detects a collision of the vehicle 1 and determines that a collision has occurred, the control device ECU operates the inflator 14.

The airbag 20 includes a bag main body 21 and a connecting member 35.

The bag main body 21 has an inflow opening 23 through which inflation gas flows in and the peripheral edge of the inflow opening 23 is disposed so as to be fixed to the case 12 as an accommodation part. As illustrated in FIG. 1, in the bag main body 21, the inflation completion shape is a loop shape including an upper portion 31 and a lower portion 30 which branch up and down from the inflow opening 23 side and a rear portion 32 which is a mutual connecting part between rear ends 30a and 31a of the upper portion 31 and the lower portion 30 as a confluence part on a tip end side. The inflow opening 23 is disposed on a lower surface on a front end side of the lower portion 30.

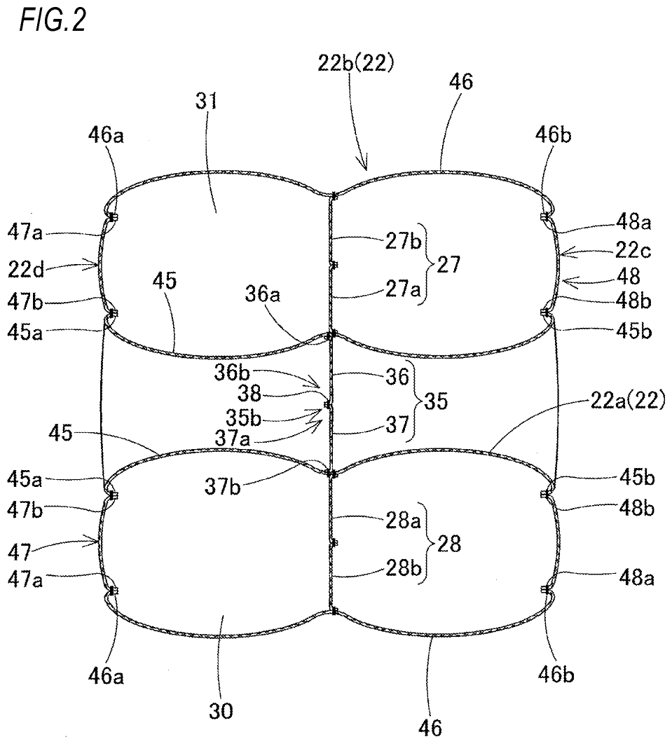

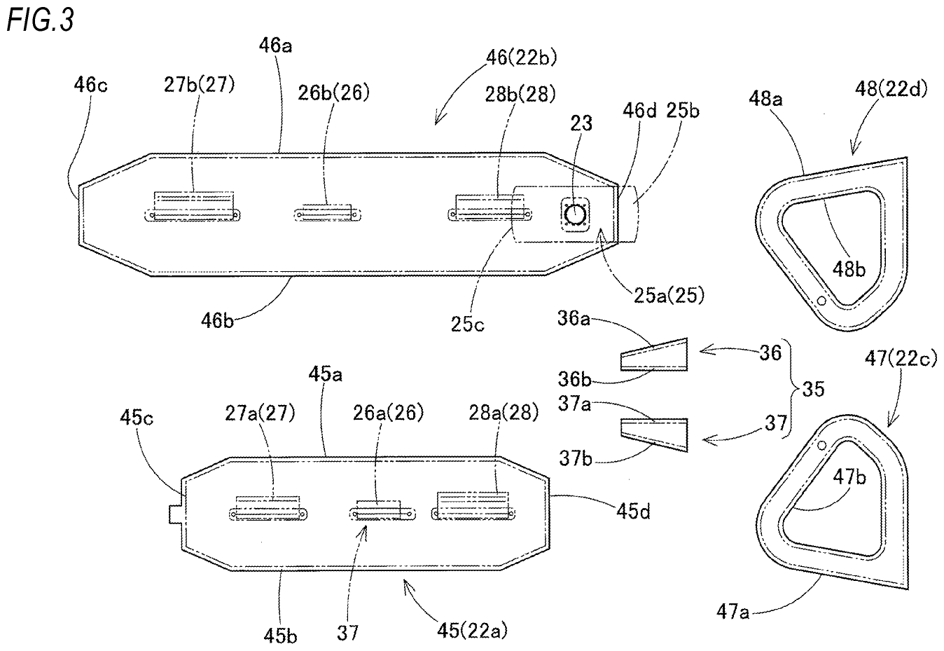

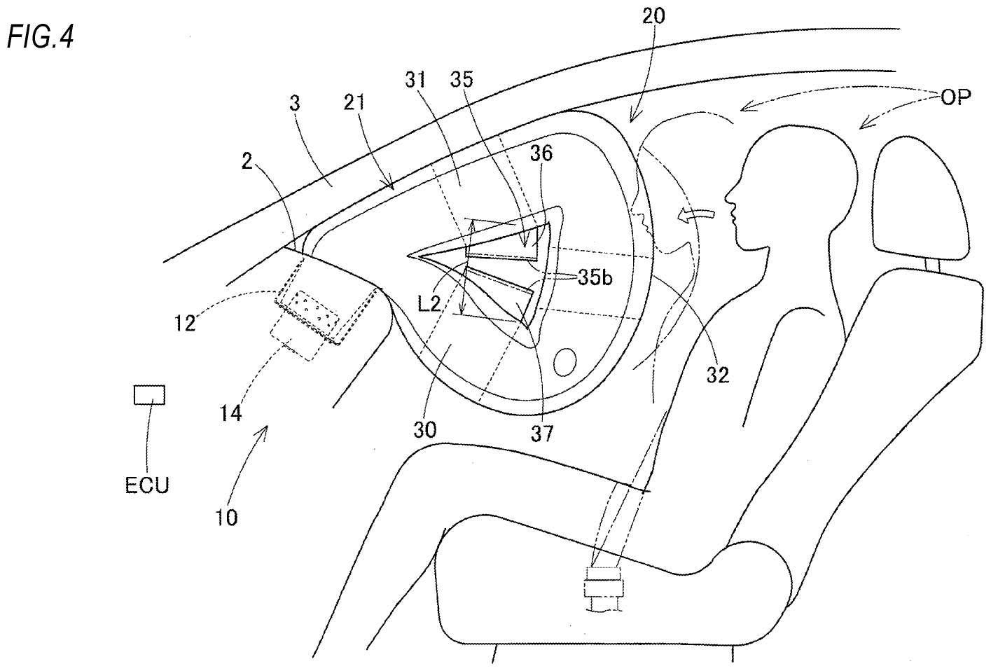

The connecting member 35 is disposed between the upper portion 31 and the lower portion 30. Further, the connecting member 35 is disposed by connecting the upper portion 31 and the lower portion 30 so as to regulate the separation distance between the upper portion 31 and the lower portion 30 when the inflation is completed. The connecting member 35 is formed from a flexible woven fabric such as polyamide or polyester. Further, in a case of the embodiment, as illustrated in FIG. 3, the connecting member 35 is constituted of an upper cloth 36 and a lower cloth 37 which are vertically divided into two and have a vertically symmetric trapezoidal shape. In addition, as illustrated in FIG. 2, an upper edge 36a of the upper cloth 36 is sewn to the upper portion 31 and a lower edge 37b of the lower cloth 37 is sewn to the lower portion 30, and further a lower edge 36b of the upper cloth 36 and an upper edge 37a of the lower cloth 37 are joined with each other. A joining part 35b is formed by sewing a suture thread 38. The suture thread 38 is formed from a thread such as polyamide or polyester. When a reaction force of the bag main body 21 is extremely high when the bag main body 21 receives the occupant OP, the suture thread 38 is set to be broken as illustrated in FIG. 4 and configured so that the upper cloth 36 and the lower cloth 37 are separated from each other.

That is, as illustrated in FIG. 1, before the suture thread 38 is broken, the connecting member 35 of the first embodiment regulates the separation distance near (front edge 35a of the connecting member 35) the rear portion 32 of the upper portion 31 and the lower portion 30 as a first distance L1. Further, as illustrated in FIG. 4, when the suture thread 38 is broken, the connecting member 35 is disposed so that the separation distance on the front edge 35a side of the connecting member 35 becomes a second distance L2 longer than the first distance L1.

The base fabric constituting an outer peripheral wall 22 of the bag main body 21 is formed from a woven fabric such as polyamide or polyester. As illustrated in FIG. 3, the base fabric is constituted of an inner base fabric 45 constituting an inner wall 22a, an outer base fabric 46 constituting an outer wall 22b, a left base fabric 47 constituting a left wall 22c, and a right base fabric 48 constituting a right wall 22d. Further, the outer peripheral wall 22 is formed by sewing an outer peripheral edge 47a of the left base fabric 47 and a side edge 46a of an outer base fabric 46, sewing an inner peripheral edge 47b of the left base fabric 47 and a side edge 45a of the inner base fabric 45, sewing an outer peripheral edge 48a of the right base fabric 48 and a side edge 46b of the outer base fabric 46, sewing an inner peripheral edge 48b of the right base fabric 48 and a side edge 45b of the inner base fabric 45, sewing both ends 45c and 45d of the inner base fabric 45, and sewing both ends 46c and 46d of the outer base fabric 46. After the sewing is completed, the inflow opening 23 is used to turn over so that the seam allowance does not appear on the outer surface side.

In the bag main body 21, a rectifying cloth 25 for flowing inflation gas flowing in from the inflow opening 23 to both the left and right sides is disposed at the peripheral edge of the inflow opening 23 and connection pieces 26, 27, and 28 for connecting the inner wall 22a and the outer wall 22b are disposed so that the inner wall 22a and the outer wall 22b are not separated from each other by a predetermined distance or more. The connection pieces 26, 27, and 28 are constituted of inner cloths 26a, 27a, and 28a connected to the inner base fabric 45 and outer cloths 26b, 27b, and 28b connected to the outer base fabric 46. The connection pieces 26, 27, and 28 are disposed as follows. In the connection pieces 26, 27, and 28, the inner cloths 26a, 27a, and 28a each are connected to the inner base fabric 45 and the outer cloths 26b, 27b, and 28b each are connected to the outer base fabric 46. Next, the bag main body 21 formed by sewing the outer peripheral wall 22 is turned over through the inflow opening 23, and then corresponding inner cloths 26a, 27a, and 28a and the outer cloths 26b, 27b, and 28b are pulled out from the inflow opening 23. Next, those cloths are connected to one another and accommodated in the bag main body 21.

The rectifying cloth 25 is disposed as follows. In the rectifying cloth 25, a rectifying cloth sheet material 25a is sewn to the peripheral edge of the inflow opening 23 and the bag main body 21 is turned over through the inflow opening 23. Next, both front and rear ends 25b and 25c are pulled out from the inflow opening 23 and sewn together, and then the sewn parts are accommodated in the bag main body 21.

After forming the bag main body 21, if the connecting member 35 is sewn, the airbag 20 can be manufactured.

In the occupant protection device 10 of the first embodiment, when the airbag 20 is folded and accommodated in the case 12 and the peripheral edge of the inflow opening 23 is fixed to the case 12, and further the inflator 14 is attached to the case 12, and still further the case 12 is mounted and fixed in the instrument panel 2, and still further the lead wire for operation signal input from the control device ECU is connected to the inflator 14, it can be mounted on the vehicle 1.

Thereafter, when collision of the vehicle 1 occurs and the control device ECU detects the collision of the vehicle 1, since the inflator 14 is operated to supply the inflation gas G to the bag main body 21 of the airbag 20, the bag main body 21 is deployed and inflated rearward from the case 12 as an accommodation part.

As illustrated in FIG. 1, when the bag main body 21 of the airbag 20 completes the inflation and receives the occupant OP, the rear portion 32 receives the occupant OP. In this case, the rear portion 32 moves forward and causes the upper portion 31 and the lower portion 30 to expand. However, since the upper portion 31 and the lower portion 30 are connected by the connecting member 35 having flexibility and the separation distance (first distance L1) between the upper portion 31 and the lower portion 30 is not increased, the forward movement of the rear portion 32 is restricted. Therefore, the reaction force of the bag main body 21 is secured, and thus the occupant OP can be accurately received. In addition, since the bag main body 21 is merely provided with the connecting member 35 between the upper portion 31 and the lower portion 30 on the front side of the rear portion 32 and does not have an inflating part, the volume thereof can be reduced. Thus, when the inflation gas G flows in, the inflation can be completed quickly.

Therefore, in the occupant protection device 10 of the first embodiment, the bag main body 21 of the airbag 20 can quickly complete the inflation, and further the bag main body 21 of the airbag 20 after the completion of inflation can secure a stable reaction force when receiving the occupant.

Further, in the occupant protection device 10 of the first embodiment, the connecting member 35 is disposed so that it is possible to adjust the separation distance between the upper portion 31 and the lower portion 30 to at least two long and short types of the first distance L1 and the second distance L2 which is longer than the first distance L1, before and after break of the suture thread 38 of the joining part 35b.

Therefore, in the first embodiment, when the bag main body 21 receives the occupant OP by the rear portion 32, if the separation distance between the upper portion 31 and the lower portion 30 is set to the first distance L1, the reaction force can be increased and the occupant OP can be received, and thus the occupant OP which moves forward with high kinetic energy can be accurately received. However, when the reaction force becomes extremely large, that is, in that case, a large tensile force acts to separate the upper portion 31 and the lower portion 30 from each other. Thus, as illustrated in FIG. 4, the connecting member 35 can break the suture thread 38 of the joining part 35b and the separation distance between the upper portion 31 and the lower portion 30 can be increased from the first distance L1 to the second distance L2. As a result, an increase in the reaction force can be suppressed and the occupant OP received by the bag main body 21 can be suitably protected.

In particular, in this case, since the connecting member 35 which connects the upper portion 31 and the lower portion 30 to each other releases the connection between the upper portion 31 and the lower portion 30, the upper portion 31 and the lower portion 30 simply deform in a bending manner when receiving the occupant OP. Therefore, compared with a case where the separation distance between the upper portion 31 and the lower portion 30 is maintained as the first distance L1, the reaction force against the occupant OP can be greatly reduced.

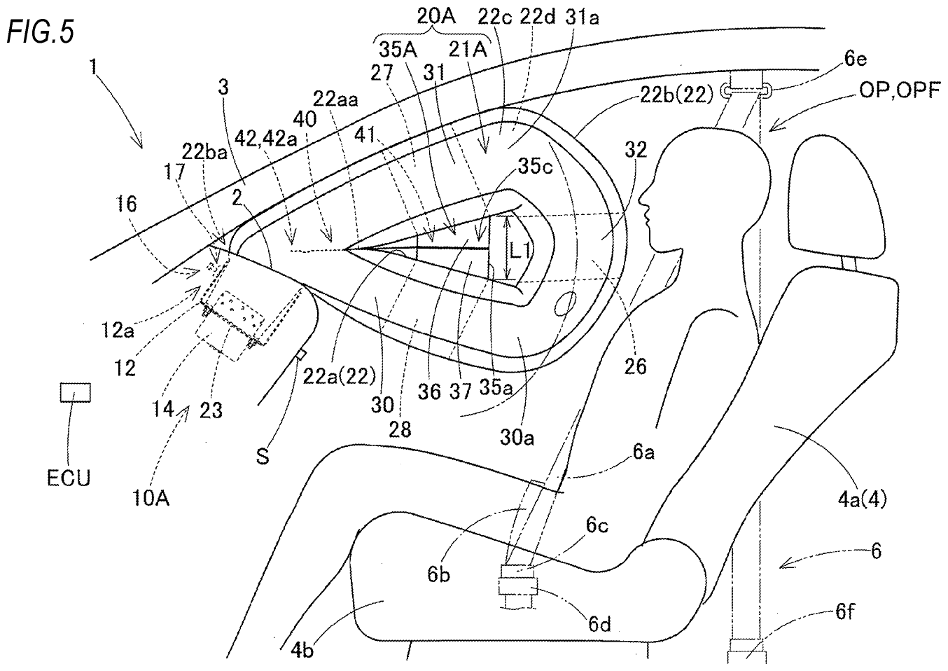

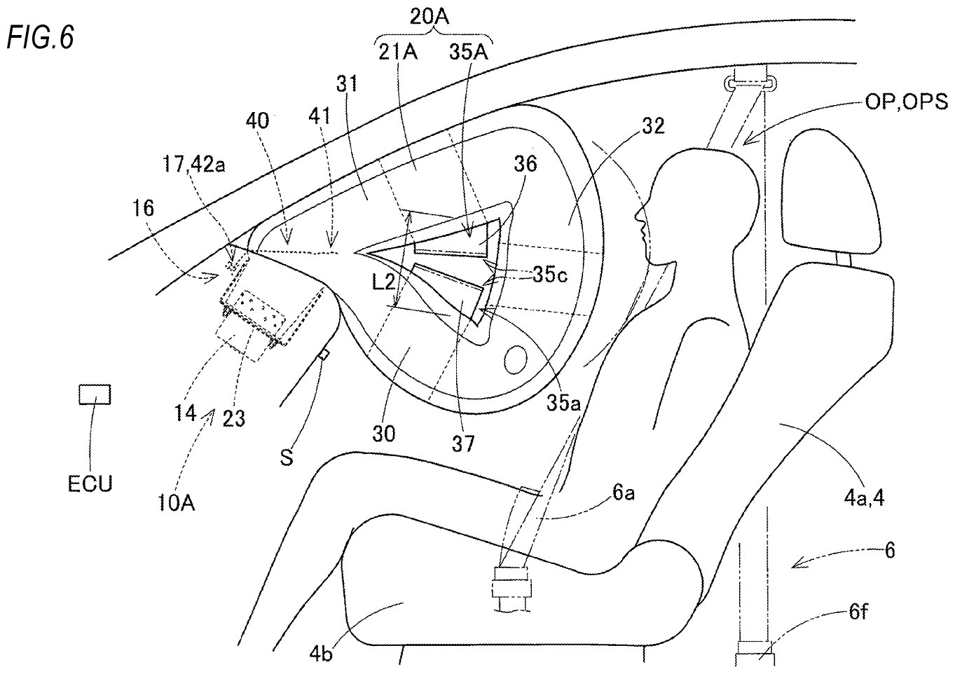

The adjustment of the second distance L2 of the connecting member 35 in this case may cause the connecting member 35 to break the suture thread 38 and disconnect the upper portion 31 and the lower portion 30 as in the first embodiment. However, as similar to an occupant protection device 10A of a second embodiment illustrated in FIGS. 5 and 6, an actuator 16 as a length adjusting unit may be configured to be able to adjust a separation distance between the upper portion 31 and the lower portion 30 to a first distance L1 and a second distance L2 which is longer than the first distance L1. In a case of the second embodiment, the operation (adjustment of the separation distance) of the actuator 16 as the length adjusting unit is controlled by the control device ECU.

The occupant protection device 10A of the second embodiment is configured to include an airbag 20A including a bag main body 21A and a connecting member 35A, an inflator 14 which supplies inflation gas to the bag main body 21A, the actuator 16 described above, a connection maintaining material 40 for connecting a base portion 42 side to a locking pin 17 of the actuator 16, and the control device ECU. The occupant protection device 10A is configured to further include a camera S as an occupant detecting unit for detecting whether the physique of the occupant OP is a large size occupant OPF or a small size occupant OPS. Furthermore, in the occupant protection device 10A of the second embodiment, the seat belt device 6 is configured to include a winding mechanism 6f provided with a pretensioner mechanism and a force limiter mechanism for restraining the occupant OP (OPF or OPS) seated on the seat 4.

The actuator 16 is formed of a micro gas generator (MGG) or the like and is operated so as to pull out the locking pin 17 from a connection hole 42a provided in the base portion 42 of the connection maintaining material 40 when an operation signal from the control device ECU is input. In a case of the second embodiment, the actuator 16 is fixed to a front edge 12a side of the case 12.

The airbag 20A of the second embodiment includes the bag main body 21A and the connecting member 35A.

As similar to the bag main body 21 of the first embodiment, the bag main body 21A has the inflow opening 23 and the peripheral edge of the inflow opening 23 is disposed so as to be fixed to the case 12. As illustrated in FIGS. 5 and 6, in the bag main body 21, the inflation completion shape is a loop shape including the upper portion 31 and the lower portion 30 which branch up and down from the inflow opening 23 side and the rear portion 32 which is a mutual connecting part between the rear ends 30a and 31a of the upper portion 31 and the lower portion 30. The inflow opening 23 is disposed on the lower surface on the front end side of the lower portion 30.

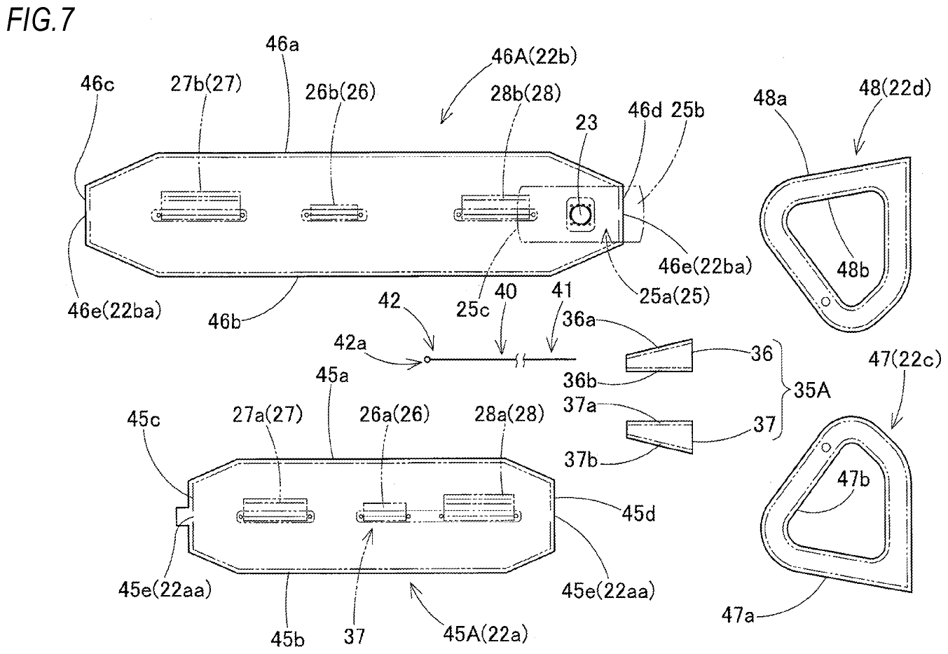

As illustrated in FIG. 7, the base fabric constituting the outer peripheral wall 22 of the bag main body 21A is constituted of an inner base fabric 45A constituting the inner wall 22a, an outer base fabric 46A constituting the outer wall 22b, the left base fabric 47 constituting the left wall 22c, and the right base fabric 48 constituting the right wall 22d. Further, as similar to the first embodiment, the outer peripheral wall 22 of the bag main body 21A is formed by sewing the outer peripheral edge 47a of the left base fabric 47 and the side edge 46a of the outer base fabric 46A, sewing the inner peripheral edge 47b of the left base fabric 47 and the side edge 45a of the inner base fabric 45A, sewing the outer peripheral edge 48a of the right base fabric 48 and the side edge 46b of the outer base fabric 46A, sewing the inner peripheral edge 48b of the right base fabric 48 and the side edge 45b of the inner base fabric 45A, sewing the both ends 45c and 45d of the inner base fabric 45A, and sewing the both ends 46c and 46d of the outer base fabric 46A. After the sewing is completed, the inflow opening 23 is used to turn over so that the seam allowance does not appear on the outer surface side.

In the second embodiment, non-sewn parts 45e and 46e are disposed near the center in the left-right direction at the mutual sewn part of both the ends 45c and 45d of the inner base fabric 45A and the mutual sewn part of both the ends 46c and 46d of the outer base fabric 46A and the inner wall 22a and the outer wall 22b are formed with through holes 22aa and 22ba made of the non-sewn parts 45e and 46e through which the connection maintaining material 40 is passed.

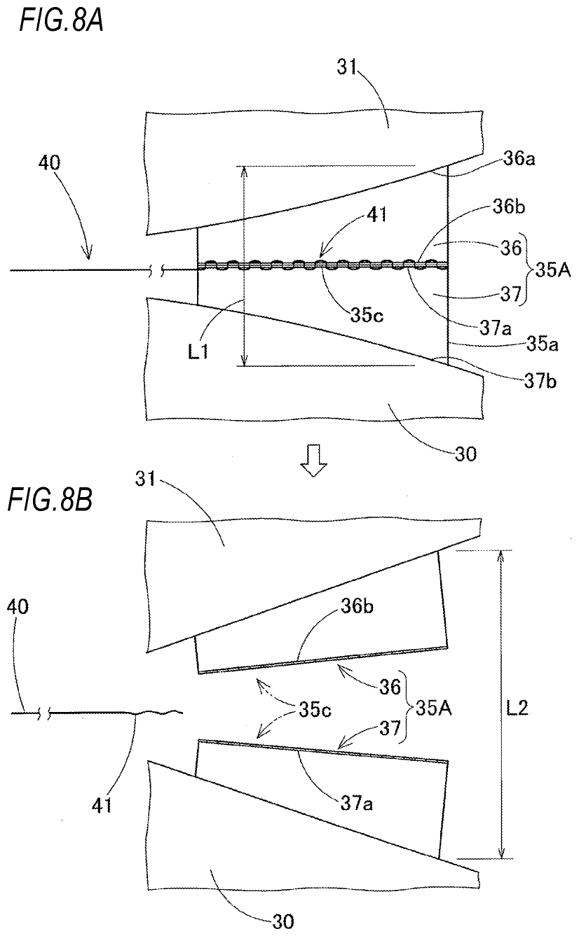

As illustrated in FIG. 8A, in the connection maintaining material, a tip end (rear end) 41 side is disposed so that a joining part 35c between the lower edge 36b of the upper cloth 36 sewn to the upper portion 31 in the connecting member 35A and the upper edge 37a of the lower cloth 37 sewn to the lower portion 30 in the connecting member 35A is sewn. In the connection maintaining material 40, when the bag main body 21A is inflated, if the connection hole 42a on the base portion 42 side is locked to the locking pin 17 of the actuator 16, as illustrated in FIGS. 6 and 8B, the tip end 41 side comes off from the joining part 35c between the lower edge 36b of the upper cloth 36 and the upper edge 37a of the lower cloth 37 and the upper cloth 36 and the lower cloth 37 are separated from each other, whereby the bag main body 21A is inflated with the second distance L2 as the separation distance in the vicinity (front edge 35a of the connecting member 35A) of the rear portion 32 between the upper portion 31 and the lower portion 30 of the bag main body 21A. In addition, in the connection maintaining material 40, when the bag main body 21A is inflated, if the locking pin 17 of the actuator 16 is separated from the connection hole 42a on the base portion 42 side, as illustrated in FIGS. 5 and 8A, the tip end 41 side does not come off from the joining part 35c between the lower edge 36b of the upper cloth 36 and the upper edge 37a of the lower cloth 37, whereby the connecting member 35A constituted of the upper cloth 36 and the lower cloth 37 inflates the bag main body 21A with the first distance L1 shorter than the second distance L2 as the separation distance at the front edge 35a of the connecting member 35A between the upper portion 31 and the lower portion 30 of the bag main body 21A.

The seat belt device 6 is configured so that the shoulder belt 6a is connected to the winding mechanism 6f via a guide 6e and the tensile force of the shoulder belt 6a can be adjusted in two steps (for example, 4 KN and 3 KN) of high and low at the time of the vehicle collision. The adjustment is performed by being controlled by the control device ECU depending on whether the speed of the vehicle 1 is a high speed or a low or moderate speed.

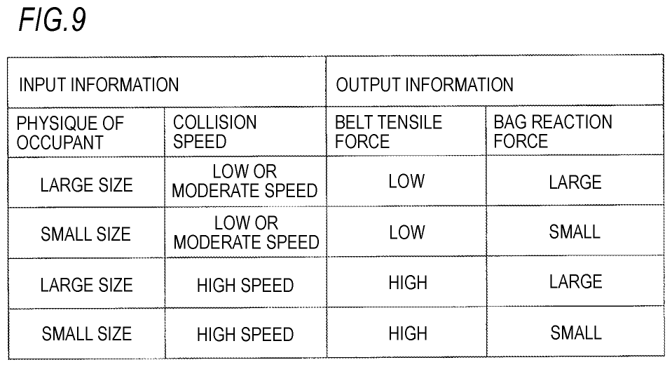

Further, at the time of the vehicle collision, the control device ECU controls the operation of the inflator 14 which supplies inflation gas to the airbag 20A and detects whether the speed of the vehicle 1 is a high speed (for example, 55 km/h or more) or a low or moderate speed (less than 55 km/h). In addition, based on the signal (image data) from the camera S as the occupant detecting unit, depends on whether the occupant is a large size occupant OPF or a small size occupant OPS, as illustrated in FIG. 9, the control device ECU controls the adjustment (adjustment of the extent of the reaction force of the bag main body 21A) at the time of operation of the actuator 16 as the length adjusting unit and the adjustment of the extent of the tensile force in the winding mechanism 6f of the seat belt device 6.

That is, when the collision of the vehicle 1 is detected and the control device ECU controls the inflator 14 to operate, as illustrated in FIG. 5, if the control device ECU determines that the occupant OP seated on the seat 4 is a large size occupant OPF by the camera S as the occupant detecting unit, the control device ECU operates the actuator 16 as the length adjusting unit to ensure a large reaction force of the bag main body 21A when the inflation is completed. In addition, the control device ECU makes the locking pin 17 pulled out from the connection hole 42a of the connection maintaining material 40 and makes the tip end 41 side of the connection maintaining material 40 not pulled out from the joining part 35c, whereby the control device ECU adjusts the separation distance between the upper portion 31 and the lower portion 30 of the main body 21A to be the first distance L1. Further, in this case, when the control device ECU detects that the speed of vehicle 1 is a high speed, the control device ECU adjusts the tensile force of the shoulder belt 6a to be a high tensile force by adjusting the winding mechanism 6f of the seat belt device 6. Alternatively, in this case, when the control device ECU detects that the speed of vehicle 1 is a low or moderate speed, the control device ECU adjusts the tensile force of the shoulder belt 6a to be a low tensile force by adjusting the winding mechanism 6f of the seat belt device 6 (see FIG. 9).

On the other hand, as illustrated in FIG. 6, when the control device ECU determines that the occupant OP seated on the seat 4 is a small size occupant OPS by the camera S as the occupant detecting unit, a state where the locking pin 17 is inserted into the connection hole 42a is maintained without operating the actuator 16 as the length adjusting unit so that the reaction force of the bag main body 21A at the completion of inflation can be reduced without increasing it. Thereby, when the bag main body 21A is deployed and inflated, the control device ECU makes the tip end 41 side of the connection maintaining material 40 of which the base portion 42 side is locked to the locking pin 17 pulled out from the joining part 35c of the connecting member 35A and adjusts the separation distance between the upper portion 31 and the lower portion 30 of the bag main body 21A to be the second distance L2. Further, in this case, when the control device ECU detects that the speed of vehicle 1 is a high speed, the control device ECU adjusts the tensile force of the shoulder belt 6a to be a high tensile force by adjusting the winding mechanism 6f of the seat belt device 6. Alternatively, in this case, when the control device ECU detects that the speed of vehicle 1 is a low or moderate speed, the control device ECU adjusts the tensile force of the shoulder belt 6a to be a low tensile force by adjusting the winding mechanism 6f of the seat belt device 6 (see FIG. 9).

That is, in the occupant protection device 10A of the second embodiment, when the collision of the vehicle 1 occurs, if the seated occupant OP is a large size occupant OPF, the control device ECU operates the inflator 14 to inflate the bag main body 21A of the airbag 20A, detects that the seated occupant OP is a large size occupant OPF based on the image data from the camera S as the occupant detecting unit, and operates the actuator 16 as the length adjusting unit. Therefore, the tip end 41 side of the connection maintaining material 40 can be moved together with the joining part 35c of the connecting member 35A and the bag main body 21A is adjusted so that the separation distance between the upper portion 31 and the lower portion 30 becomes the first distance L1. As a result, the bag main body 21A which has completed the inflation can accurately receive the large size occupant OPF with high kinetic energy by reducing the reaction force (see FIG. 5). Further, in this case, when the vehicle 1 collides at a high speed, the control device ECU makes the shoulder belt 6a hung on the occupant OP pulled by increasing the tensile force of the shoulder belt 6a of the seat belt device 6, in such a manner that the forward movement of the large size occupant OPF with high kinetic energy can be accurately suppressed. Further, when the speed of the vehicle 1 at the collision is a low or moderate speed, the control device ECU makes the shoulder belt 6a hung on the occupant OP pulled by decreasing the tensile force of the shoulder belt 6a of the seat belt device 6, in such a manner that the forward movement of the large size occupant OPF having relatively low kinetic energy can be accurately suppressed.

Further, at the time of the vehicle collision, if the seated occupant OP is a small size occupant OPS, the control device ECU operates the inflator 14 to inflate the bag main body 21A of the airbag 20A, detects that the seated occupant OP is a small size occupant OPS based on the image data from the camera S as the occupant detecting unit, and makes the locking state of the locking pin 17 to the connection hole 42a maintained without operating the actuator 16 as the length adjusting unit, whereby the tip end 41 side of the connection maintaining material 40 is pulled out from the joining part 35c of the connecting member 35A of the bag main body 21A in an inflating state. Therefore, the bag main body 21A in an inflating state performs the adjustment so that the separation distance between the upper portion 31 and the lower portion 30 becomes the second distance L2. As a result, the bag main body 21A which has completed the inflation can suitably receive the small size occupant OPS with low kinetic energy by reducing the reaction force (see FIG. 6). Further, in this case, when the vehicle 1 collides at a high speed, the control device ECU makes the shoulder belt 6a hung on the occupant OP pulled by increasing the tensile force of the shoulder belt 6a of the seat belt device 6, in such a manner that the forward movement of the small size occupant OPS with high kinetic energy can be accurately suppressed. Further, when the speed of the vehicle 1 at the collision is a low or moderate speed, the control device ECU makes the shoulder belt 6a hung on the occupant OP pulled by decreasing the tensile force of the shoulder belt 6a of the seat belt device 6, in such a manner that the forward movement of the small size occupant OPS having relatively low kinetic energy can be accurately suppressed.

That is, the occupant protection device 10A of the second embodiment can protect the occupant OP (OPF or OPS) accurately according to the physique of the occupant OP (OPF or OPS) and the speed of the vehicle 1.

In the occupant protection device 10A of the second embodiment, the tensile force of the shoulder belt 6a by the winding mechanism 6f of the seat belt device 6 is adjusted to be high or low according to the speed of the vehicle 1. However, it may protect the occupant by adjusting the reaction force of the bag main body 21A according to the physique of the occupant, without adjusting the tensile force of the belt as follows. The control device ECU detects whether the occupant OP seated on the seat 4 is a large size occupant OPF or a small size occupant OPS with the camera S as the occupant detecting unit and, if the occupant OP is a large size occupant OPF, the actuator 16 as the length adjusting unit is operated to increase the reaction force of the bag main body 21A at the completion of inflation. Further, if the occupant OP is a small size occupant OPS, the actuator 16 as the length adjusting unit is not operated to reduce the reaction force of the bag main body 21A at the completion of inflation.

That is, even in this case, as illustrated in FIG. 5, when the bag main body 21A at the completion of inflation receives the large size occupant OPF, the control device ECU adjusts the actuator 16 as the length adjusting unit so that the separation distance between the upper portion 31 and the lower portion 30 becomes the first distance L1, and thus the reaction force is increased and it is possible to accurately receive the large size occupant with high kinetic energy. On the other hand, as illustrated in FIG. 6, when the bag main body 21A at the completion of inflation receives the small size occupant OPS, the control device ECU adjusts the actuator 16 as the length adjusting unit so that the separation distance between the upper portion 31 and the lower portion 30 becomes the second distance L2, and thus the reaction force is reduced and it is possible to suitably receive the small size occupant OPS with low kinetic energy.

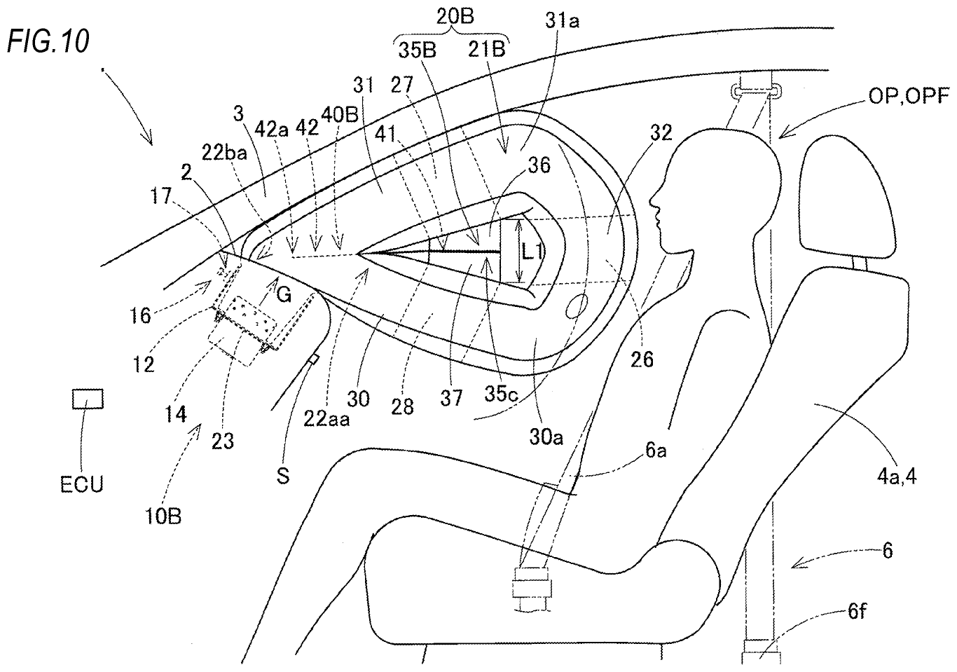

The adjustment of the second distance L2 of the connecting member 35A in the second embodiment is configured so that the joining of the joining part 35c is released and the connecting member 35A releases the connection between the upper portion 31 and the lower portion 30. However, as similar to a connecting member 35B of an occupant protection device 10B of a third embodiment illustrated in FIGS. 10 to 12B, even when the separation distance becomes the second distance L2, the adjustment may be performed so that the connection state of the upper portion 31 and the lower portion 30 is maintained and the separation distance is made longer than the first distance L1.

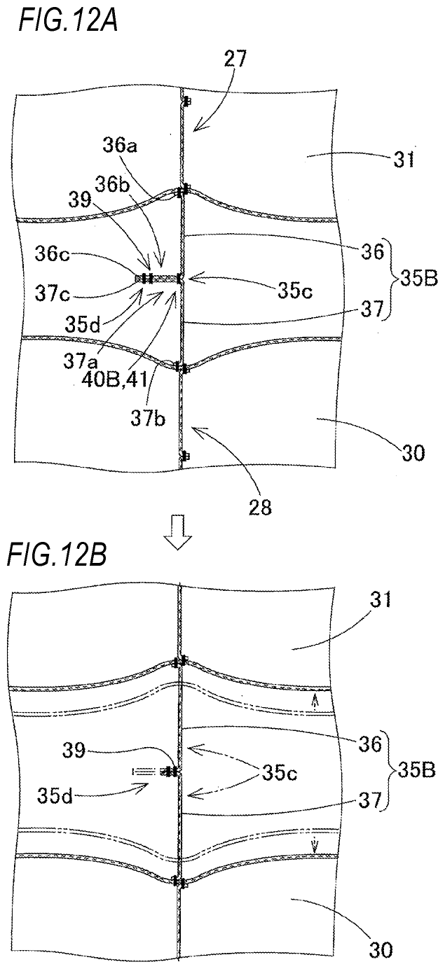

As illustrated in FIG. 12A, the connecting member 35B is disposed so that the tip end 41 side of a connection maintaining material 40B sews the joining part 35c between the lower edge 36b side of the upper cloth 36 and the upper edge 37a side of the lower cloth 37. Further, in the connecting member 35B disposed in an airbag 20B, the lower edge 36b side of the upper cloth 36 and the upper edge 37a side of the lower cloth 37 are sewn together at the edges 36c and 37c on the tip end side from the joining part 35c by the suture thread 39 which does not break.

In a bag main body 21B of the airbag 20B of the third embodiment which has the upper portion 31, the lower portion 30, and the rear portion 32 as similar to the bag main body 21A, the connecting member 35B is disposed to connect the upper portion 31 and the lower portion 30 to each other. That is, the upper edge 36a of the upper cloth 36 away from the joining part 35c is sewn to the upper portion 31 and the lower edge 37b of the lower cloth 37 is sewn to the lower portion 30.

In the occupant protection device 10B of the third embodiment, other than the configuration of the connecting member 35B, the bag main body 21B and the connection maintaining material 40B are similar as those in the second embodiment, and further the other inflator 14, the actuator 16, the seat belt device 6, the camera S, and the control device ECU also have the configuration similar to those in the second embodiment.

In the occupant protection device 10B of the third embodiment, when the separation distance between the upper portion 31 and the lower portion 30 is the first distance L1, the actuator 16 is operated and the locking pin 17 is removed from the connection hole 42a on the base portion 42 side of the connection maintaining material 40B to inflate the bag main body 21B. In this case, the tip end 41 side of the connecting member 35B does not come off from the joining part 35c of the connecting member 35B and, with the connecting member 35B, the bag main body 21B at the completion of inflation completes the inflation in a state where the separation distance between the upper portion 31 and the lower portion 30 becomes the first distance L1 by the connecting member 35B, as illustrated in FIGS. 10 and 12A. Therefore, even when the large size occupant OPF is received, the reaction force can be increased and the large occupant OPF can be suitably received.

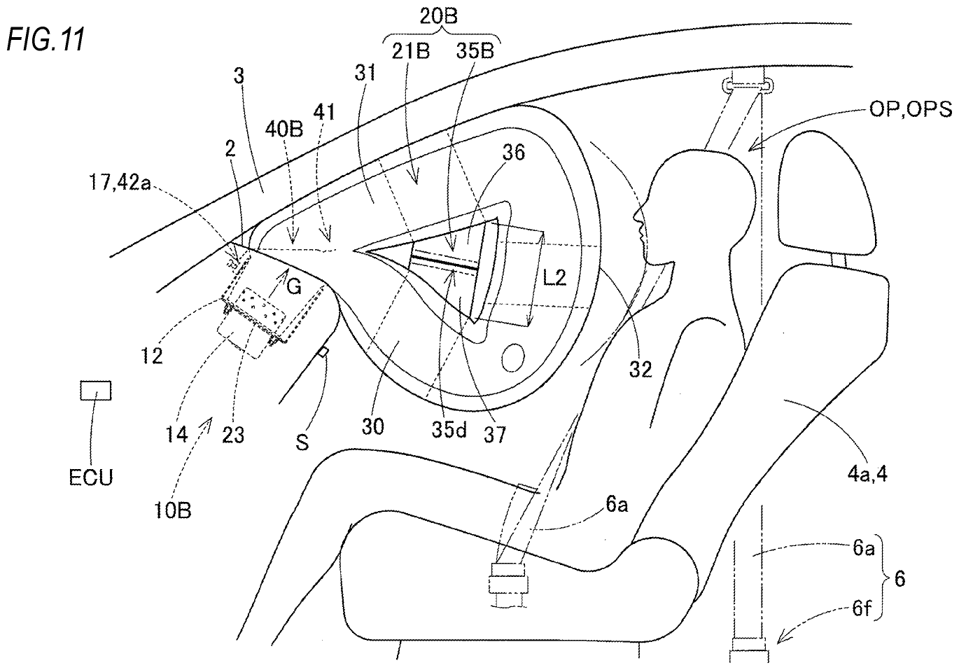

On the other hand, when the separation distance between the upper portion 31 and the lower portion 30 is set to the second distance L2 longer than the first distance L1, the locking pin 17 is inserted into the connection hole 42a without operating the actuator 16. Therefore, when the bag main body 21B is deployed and inflated, the tip end 41 side of the connection maintaining material 40B comes off from the joining part 35c of the connecting member 35B and the joining state of the joining part 35c is released. Further, the connecting member 35B maintains the connection state between the upper cloth 36 and the lower cloth 37 at the joining part 35d sewn with the suture thread 39 which does not break. As a result, as illustrated in FIGS. 11 and 12B, since the bag main body 21B completes the inflation by setting the separation distance between the upper portion 31 and the lower portion 30 to the second distance L2 longer than the first distance L1, when receiving a small size occupant OPS, the reaction force can be suppressed and the small size occupant OPS can be suitably received.

In the third embodiment, when the separation distance between the upper portion 31 and the lower portion 30 becomes the second distance L2 longer than the first distance L1, the upper portion 31 and the lower portion 30 are easily deformed in a bending manner. In particular, the lower portion 30 increases an angle so as to move away from the upper portion 31 and protrudes from the instrument panel 2 into a free space and it is easily deformed in a bending manner. Therefore, when the separation distance between the upper portion 31 and the lower portion 30 becomes the second distance L2 longer than the first distance L1, even when the upper portion 31 and the lower portion 30 are connected by the connecting member 35B, the reaction force when receiving the occupant can be reduced.

The operation of the seat belt device 6 of the third embodiment is similar to that of the second embodiment. The control device ECU adjusts the winding mechanism 6f to increase the tensile force of the shoulder belt 6a when the speed of the vehicle 1 is a high speed and decrease the tensile force of the shoulder belt 6a when the speed is a low or moderate speed and the seat belt device 6 restrains the occupant OP (large size occupant OPF or small size occupant OPS) (see FIG. 9).

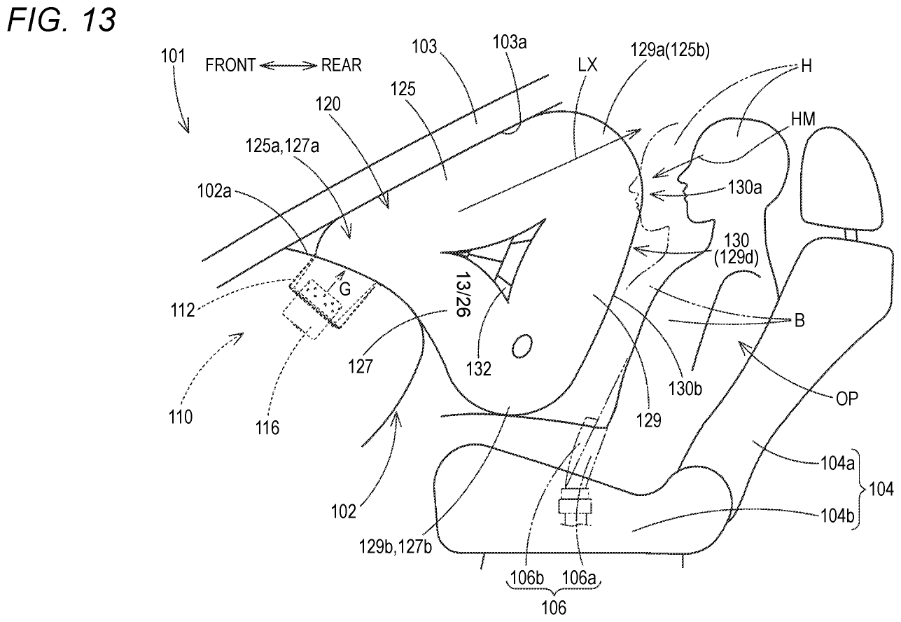

Hereinafter, a fourth embodiment of the invention will be described with reference to the drawings. An occupant protection device 110 of the fourth embodiment is mounted on an upper surface 102a side of an instrument panel 102 on a front side of a seat 104 of a passenger seat of a vehicle 101, as illustrated in FIG. 13. The seat 104 of the passenger seat includes a backrest portion 104a and a seat portion 104b and an occupant OP wearing a shoulder belt 106a and a lap belt 106b of a seat belt 106 is seated on the seat 104.

The occupant protection device 110, for protecting an occupant OP seated in the seat 104, of the fourth embodiment includes an airbag 120 and an inflator 116 which supplies inflation gas G to the airbag 120. The airbag 120 is folded and accommodated in a case 112 as an accommodation part and the inflator 116 is attached to the case 112 so that the inflation gas can be supplied to the folded airbag 120.

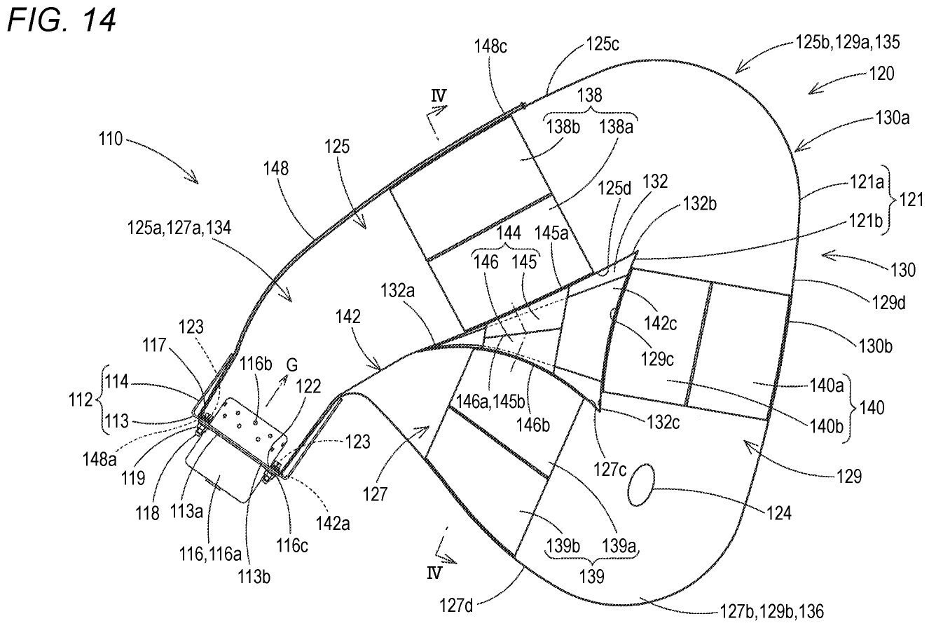

As illustrated in FIG. 14, the inflator 116 includes a main body portion 116a in which a gas discharge port 116b for discharging the inflation gas G is disposed and a flange portion 116c extending from an outer peripheral surface of the main body portion 116a.

The case 112 is made of a sheet metal including a bottom wall portion 113 having a rectangular plate shape and a peripheral wall portion 114 having a square tubular shape and extending from an outer peripheral edge of the bottom wall portion 113. The case 112 is attached and fixed to a vehicle-body-side member (not illustrated) on the upper surface side of the instrument panel 102. The inflator 116 and the airbag 120 are attached and fixed to the bottom wall portion 113 using a retainer 117 having a square annular shape.

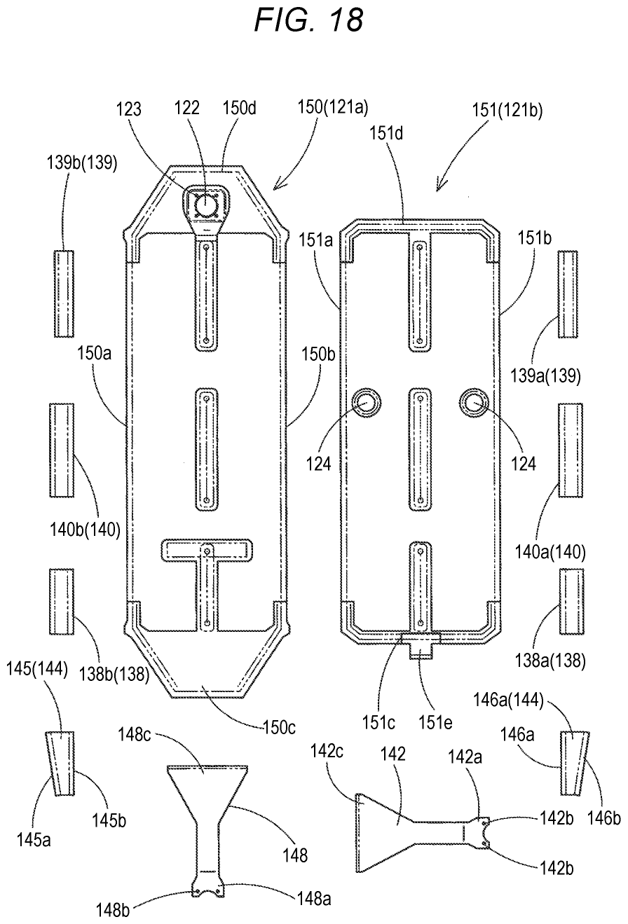

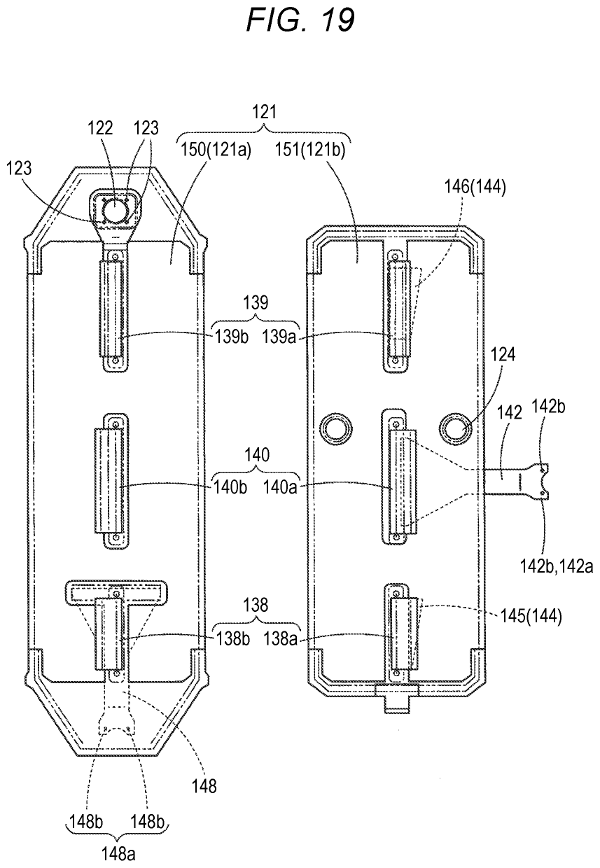

The retainer 117 is disposed on an inner peripheral surface side of an inflow opening 122 of the airbag 120. A plurality (four in the fourth embodiment) of bolts 118 extending from the retainer 117 are inserted into mounting holes 123 (see FIGS. 18 and 19) at the peripheral edge of the inflow opening 122, and further the bolts 118 are inserted into the bottom wall portion 113 of the case 112 and the flange portion 116c of the inflator 116, and then a nut 119 is fastened to each bolt 118, whereby the retainer 117 attaches and fixes the peripheral edge of the inflow opening 122 of the airbag 120 and the flange portion 116c of the inflator 116 to the bottom wall portion 113 of the case 112.

As for the operation of the inflator 116, when a control device (not illustrated) receives a signal from a collision detection sensor (not illustrated) disposed in the front bumper or the like, which detects a collision of the vehicle 101 and determines that a collision has occurred, the inflator 116 is operated.

The airbag 120 is folded and accommodated in the case 112 as an accommodation part. When the inflation gas G flows in, the airbag 120 protrudes rearward from the inside of the case 112 disposed on the upper surface 102a side of the instrument panel 102 while pushing and opening a door portion of the instrument panel 102 (not illustrated) so as to block a space between the instrument panel 102 and a windshield 103 above the instrument panel 102. Thereby, the airbag 120 is inflated to be able to receive the occupant OP moving forward.

That is, in the fourth embodiment, the airbag 120 is set as the structure which is deployed and inflated from the case 112 as an accommodation part disposed at the upper surface 102a side of the instrument panel 102.

As illustrated in FIGS. 13 to 15, when the inflation is completed, the airbag 120 has a substantially triangular annular shape in which a lower inflating portion 127 as a first inflating portion which extends in a substantially columnar shape from the case 112 as the accommodation part along the upper surface 102a of the instrument panel 102 as the vehicle body side part and is supported by the instrument panel 102, an upper inflating portion 125 as a second inflating portion extending in a substantially columnar shape from an end portion (upper end or front end) 127a in an up-down direction of the lower inflating portion 127 as the first inflating portion to the rear side on a protection target part H side of the occupant OP, and a rear inflating portion 129 as a third inflating portion which extends from the rear end 125b of the upper inflating portion 125 as the second inflating portion and intersects the other end portion (lower end or rear end) 127b in the up-down direction of the lower inflating portion 127 as the first inflating portion are disposed so as to surround the hollow portion 132. In other words, when the inflation is completed, the airbag 120 has a substantially triangular annular shape including an upper inflating portion 125 extending obliquely upward and rearward from the case 112 so as to have a substantially columnar shape, a rear inflating portion 129 extending downward from a rear end 125b of the upper inflating portion 125 so as to have a substantially columnar shape, and a lower inflating portion 127 extending forward from a lower end 129b of the rear inflating portion 129 along the upper surface 102a side of the instrument panel 102 so as to have a substantially columnar shape and intersect at a vicinity of a front end 125a of the upper inflating portion 125 on the case 112 side. In the center in a front-rear direction, the airbag 120 has a hollow portion 132 of a non-inflatable portion which does not allow the inflation gas G to flow. In a case of the fourth embodiment, when the airbag 120 completes inflation, an upper surface 125c side of the upper inflating portion 125 abuts on a lower surface 103a of the windshield 103 and a lower surface 127d side of the lower inflating portion 127 is supported by the upper surface 102a of the instrument panel 102.

As illustrated in FIG. 14, the hollow portion 132 has a substantially triangular shape surrounded by a lower surface 125d of the upper inflating portion 125, an upper surface 127c of the lower inflating portion 127, and a front surface 129c of the rear inflating portion 129. A front apex portion 132a of the front end is a tapered portion which intersects the curved surface of the lower surface 125d of the upper inflating portion 125 and the upper surface 127c of the lower inflating portion 127. An upper apex portion 132b of the rear upper end is a tapered portion which intersects the curved surface of the lower surface 125d of the upper inflating portion 125 and the front surface 129c of the rear inflating portion 129. A lower apex portion 132c of the rear lower end is a tapered portion which intersects the curved surface of the upper surface 127c of the lower inflating portion 127 and the front surface of the rear inflating portion 129. That is, in a case of the fourth embodiment, the airbag 120 is in a state where the inflating portions 125, 127, and 129 which swell in a substantially columnar shape are bent into a substantially triangular annular shape and the airbag 120 is in a state where a peripheral wall 121 of the airbag 120 is kinked at intersecting portions 134, 135, and 136 of the inflating portions 125, 127, and 129. Therefore, when viewed from a left-right direction, the hollow portion 132 has a substantially triangular space portion in which the apex portions 132a, 132b, and 132c are tapered.

Further, the rear inflating portion 129 of the airbag 120 at the completion of the inflation is configured so that an upper end part 129a intersecting the upper inflating portion 125 is disposed further on the rear side than a lower end part 129b intersecting the lower inflating portion 127. In the rear inflating portion 129 of the airbag 120 at the completion of inflation, a rear surface 129d side is a receiving area 130 for receiving the occupant OP, and the upper portion side of the receiving area 130 is a head receiving area 130a, and further the lower portion side is a chest receiving area 130b. In particular, in the head receiving area 130a of the airbag 120, the vicinity of the rear end 125b of the upper inflating portion 125 is set as a receiving part which receives the head H as a protection target part of the occupant OP by increasing the reaction force at the time of receiving. That is, when the inflation is completed, the upper inflating portion 125 as the second inflating portion can receive the head H of the occupant OP moving forward in the vicinity of the rear end 125b, with a direction in which the rear end 125b side extends from the front end 125a side on the case 112 side as an accommodation part obliquely upward and rearward, and further while compression deformation that allows the vicinity of the rear end 125b to approach the front end 125a side at the time of receiving is possible, the vicinity of the rear end 125b and the vicinity of the front end 125a are connected to and supported by the rear inflating portion 129 as the third inflating portion and the lower inflating portion 127 as the first inflating portion. Specifically, the upper end 29a of the rear inflating portion 129 as the third inflating portion is connected to the rear end 125b of the upper inflating portion 125 so as to restrict the vertical movement of the rear end 125b of the upper inflating portion 125 and the front end (upper end) 127a of the lower inflating portion 127 as the first inflating portion is connected to the front end 125a of the upper inflating portion 125 so that the front end 125a of the upper inflating portion 125 can secure a reaction force from the upper surface 102a of the instrument panel 102 as the vehicle body side part.

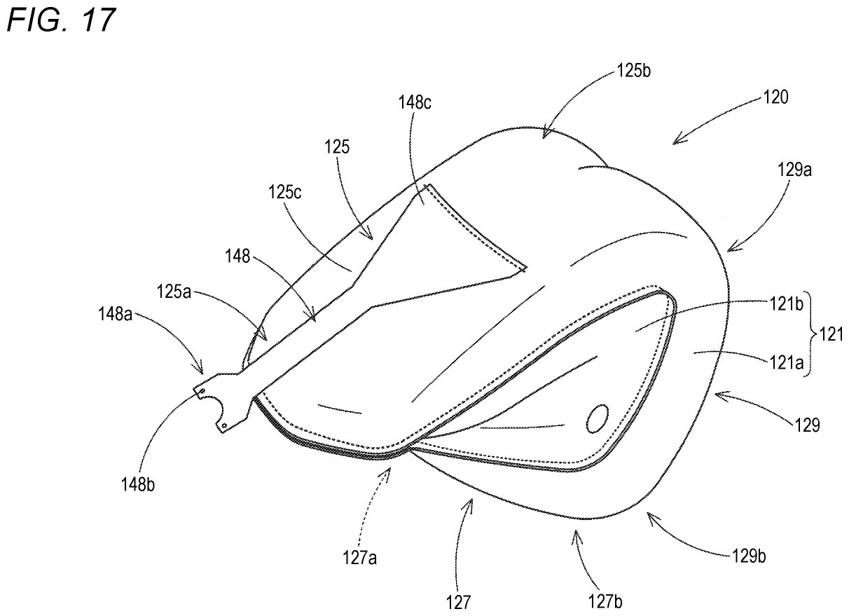

The airbag 120 is configured so that the peripheral wall 121 on the outer surface includes an outer wall 121a on the outer peripheral side and an inner wall 121b on the inner peripheral side. As illustrated in FIGS. 17 to 19, in the airbag 120, the peripheral wall 121 is formed of two sheets, an outer peripheral base fabric 150 which forms the outer wall 121a and an inner peripheral base fabric 151 which forms the inner wall 121b. Left and right side edges 151a and 151b of the inner peripheral base fabric 151 are joined (sewn) with left and right side edges 150a and 150b of the outer peripheral base fabric 150 and front and rear end edges 151c and 151d of the inner peripheral base fabric 151 are sewn together without sewing a non-sewn part 151e, and further front and rear end edges 150c and 150d of the outer peripheral base fabric 150 are sewn together, whereby the airbag 120 can form the peripheral wall 121.

The upper inflation portion 125, the lower inflating portion 127, and the rear inflating portion 129 are respectively provided with connecting pieces 138, 139, and 140 so that the separation distance between the outer wall 121a and the inner wall 121b at the time of inflation can be defined. The connecting pieces 138, 139, and 140 are constituted of inner cloths 138a, 139a, and 140a connected to the inner wall 121b and outer cloths 138b, 139b, and 140b connected to the outer wall 121a. The inner cloths 138a, 139a, and 140a are sewn to the inner peripheral base fabric 151 which forms the inner wall 121b and the outer cloths 138b, 139b, and 140b are sewn to the outer peripheral base fabric 150 which forms the outer wall 121a. In addition, when sewing the inner peripheral base fabric 151 and the outer peripheral base fabric 150, the corresponding inner cloths 138a, 139a, and 140a and the outer cloths 138b, 139b, and 140b are sewn together. Thereby, the connecting piece 138 is disposed at an intermediate part of the upper inflating portion 125 in the front-rear direction and the connecting piece 139 is disposed at an intermediate part of the lower inflating portion 127 in the front-rear direction, and further the connecting piece 140 is disposed at an intermediate part of the rear inflating portion 129 in an up-down direction.

Further, in the airbag 120, the inflow opening 122 through which the inflation gas G flows into is disposed on the outer wall 121a. The inflow opening 122 opens in a circular shape and is disposed on the outer wall 121a (outer peripheral base fabric 150) on the lower surface side of the intersecting portion 134 between the upper inflating portion 125 and the lower inflating portion 127 when the inflation of the airbag 120 is completed. As described above, the mounting hole 123 through which each bolt 118 of the retainer 117 is inserted is provided at the peripheral edge of the inflow opening 122.

Furthermore, vent holes 124 and 124 for exhausting excess inflation gas G are open in the inner wall 121b in the vicinity of the lower end 129b of the rear inflating portion 129.

A reinforcing cloth (reference numerals and letters are not shown in the drawings) having a predetermined shape is provided at the portions where the connecting cloths 128, 129, and 130, the inflow opening 122, and the vent hole 124 are provided.

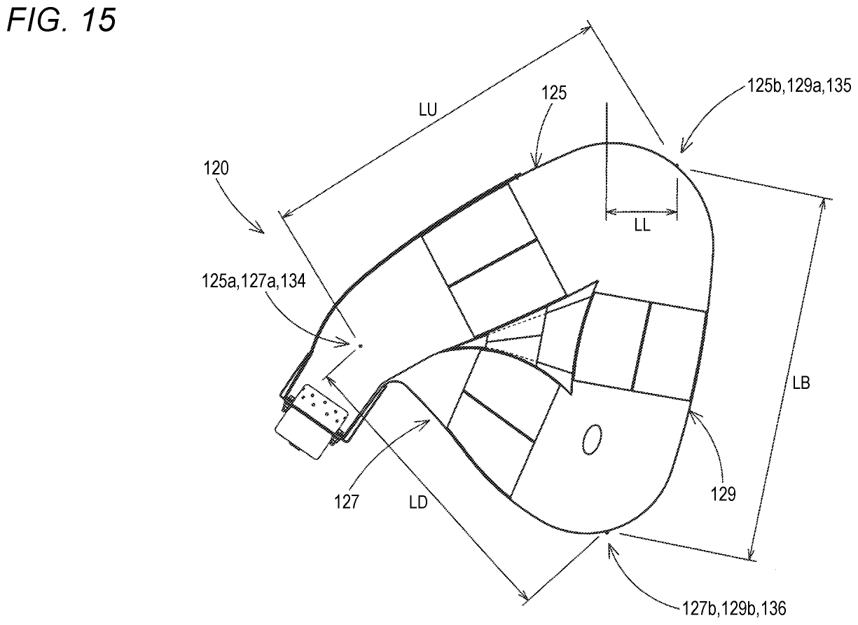

When inflation is completed in a state of being mounted on the vehicle, in the airbag 120, the upper inflating portion 125, the lower inflating portion 127, and the rear inflating portion 129 each have a shape inflating in a substantially columnar shape with cross-sectional surfaces having a substantially rectangular shape with rounded left and right edges. Length dimensions LU, LD, and LB (see FIG. 15) of respective parts are set so as to maintain the relationship of LU<LD+LB and LU>LD.

The length dimension LU is a length dimension of the upper inflating portion 125. The length dimension LU is the length dimension in the front-rear direction from a front end part 125a intersecting the lower inflating portion 127 to a rear end part 125b intersecting the rear inflating portion 129 in the upper inflating portion 125 in a state of protruding from the case 112 as the accommodation part. The length dimension LD is a length dimension in the front-rear direction from a front end part 127a intersecting the upper inflating portion 125 to a rear end part 127b intersecting the rear inflating portion 129 in the lower inflating portion 127. The length dimension LB is a length dimension in the up-down direction from the upper end part 129a intersecting the upper inflating portion 125 to the lower end part 129b intersecting the lower inflating portion 127 in the rear inflating portion 129.

The length dimension LU of the upper inflating portion 125 is shorter than the sum of the length dimension LD of the lower inflating portion 127 and the length dimension LB of the rear inflating portion 129 and longer than the length dimension LD of the lower inflating portion 127.

In a case of the fourth embodiment, the length dimension LU of the upper inflating portion 125 is about 550 mm to 650 mm and the length dimension LD of the lower inflating portion 127 is about 380 mm to 480 mm, and further the length dimension LB of the rear inflating portion 129 is about 400 mm to 500 mm. Further, a separation distance LL between the upper end part 129a and the lower end part 129b of the rear inflating portion 129 in the front-rear direction is about 50 mm to 150 mm.

The front end 125a of the upper inflating portion 125 and a front end 127a of the lower inflating portion 127 are disposed on the upper surface 102a side of the instrument panel 102 above the case 112. Further, those are a mutual intersecting portion 134 and coincide with each other. The rear end 125b of the upper inflating portion 125 and the upper end 129a of the rear inflating portion 129 are a mutual intersecting portion 135 and coincide with each other. Similarly, a rear end 127b of the lower inflating portion 127 and the lower end 129b of the rear inflating portion 129 are a mutual intersecting portion 136 and coincide with each other.

Also, there are no connecting pieces 138, 139, and 140 in the vicinity of the intersecting portions 134, 135, and 136 and the airbag 120 at the time of inflation is configured to be able to complete the inflation so that the airbag is bent at the positions of the intersecting portions 134, 135, and 136, and the upper inflating portion 125, the lower inflating portion 127, and the rear inflating portion 129 have a predetermined length, and further the airbag is smoothly formed into a substantially triangular annular shape.

Further, in the airbag 120 of the fourth embodiment, when it is inflated, the upper inflating portion 125, as the second inflating portion, is disposed so that a direction (axial direction of the substantially columnar shape, extending from the front end 125a side toward the rear end 125b side) LX extending rearward from the case 112 as an accommodation part is set to the obliquely upward rearward direction and defined as a direction along a direction opposite to a movement direction HM of a head H of the occupant OP which moves forward when the occupant protection device 110 is operated (see FIG. 13). Further, in a case of the fourth embodiment, during frontal collision of the vehicle 101, the movement direction HM of the head H of a standard male (male dummy AM50) seated on the seat 104 with the seat belt 106 is set to the obliquely forward downward direction and an axial direction LX of the upper inflating portion 125 is disposed substantially parallel to the movement direction HM and slightly above the movement direction HM of the head H.

In a case of the fourth embodiment, the upper inflating portion 125 is configured to be in contact with the lower surface 103a of the windshield 103 and is inflated in a state of being guided by the lower surface 103a of the windshield 103 of the upper inflating portion 125. Therefore, the axial direction LX approximates a protruding direction of the upper inflating portion 125 along the lower surface 3a of the windshield 103.

Further, in the airbag 120 of the fourth embodiment, a front-rear tether 142 is disposed so that the rear inflating portion 129 does not protrude so as to bend backward at the time of inflation and a substantially triangular annular state can be easily maintained when the inflation is completed. In the front-rear tether 142, a rear end 142c is sewn to the sewn part of the connecting piece 140 and the inner cloth 140a in the inner wall 121b, which is the part on the front surface 129c side of the rear inflating portion 129, and a narrow front end 142a is fixed to a rear portion 113b side of the bottom wall portion 113 of the case 112 as an accommodation part. Specifically, the front end 142a includes mounting holes 142b and 142b for inserting the bolts 118 of the retainer 117 and the front end 142a is attached and fixed to the rear portion 113b side (see FIG. 14) of the bottom wall portion 113 of the case 112 as an accommodation part by inserting the bolt 118 into each mounting hole 142b and being locked to the retainer 117. Although the rear end 142c side of the front-rear tether 142 is disposed in the hollow portion 132, the front end 142a side is inserted into the lower inflating portion 127 through the non-sewn part 151e where the end edges 151c and 151d of the inner peripheral base fabric 151 are not sewn together and is locked to the bolt 118 of the retainer 117.

Further, in the airbag 120, an up-down tether 144 which connects the upper inflating portion 125 and the lower inflating portion 127 to each other at the completion of the inflation and restricts the movement of the upper inflating portion 125 and the lower inflating portion 127 in the separation direction is disposed. The up-down tether 144 is disposed so as to block the front side of the hollow portion 132 and is constituted of an upper cloth 145 joined to the inner wall 121b of the upper inflating portion 125 and a lower cloth 146 joined to the inner wall 121b of the lower inflating portion 127. Both the upper cloth 145 and the lower cloth 146 have a trapezoidal shape with a wide width on the rear side. The upper cloth 145 connects an upper edge 145a to the inner wall 121b of the upper inflating portion 125, and specifically, sews the upper edge 145a to a part of the inner peripheral base fabric 151, which is the part in the vicinity of the sewn part of the inner cloth 138a of the connecting piece 138. Further, the lower cloth 146 connects a lower edge 146b to the inner wall 121b of the lower inflating portion 127, and specifically, sews the lower edge 146b to a part of the inner peripheral base fabric 151, which is the part in the vicinity of the sewn part of the inner cloth 139a of the connecting piece 139. Then, the lower edge 145b of the upper cloth 145 and the upper edge 146a of the lower cloth 146 are sewn together.

In addition, the airbag 120 is provided with an upper-outer tether 148 which connects the upper surface 125c side of the upper inflating portion 125 and the case 112 side of the accommodation part when inflation is completed to restrict a downward movement of the upper inflating portion 125 away from the windshield 103. In the upper-outer tether 148, a rear end 148c is sewn to the outer wall 121a in the upper inflating portion 125 in the vicinity of the sewn part of the connecting piece 138 and a front end 148a is fixed to the front portion 113a side (see FIG. 14) of the bottom wall portion 113 of the case 112 as an accommodation part. Specifically, the front end 148a is provided with mounting holes 148b and 148b for inserting the bolts 118 of the retainer 117 and is attached and fixed to the bottom wall portion 113 of the case 112 as an accommodation part by inserting the bolt 118 into each mounting hole 148b and being locked to the retainer 117.

Further, in the airbag 120, a rectifying cloth (not illustrated) for flowing inflation gas flowing from the inflow opening 122 to both the left and right sides is disposed on the peripheral edge of the inflow opening 122.

The outer peripheral base fabric 150, the inner peripheral base fabric 151, the connecting pieces 138, 139, and 140, or the various tethers 142, 144, and 148 are formed of a flexible woven fabric such as polyamide or polyester.

In the occupant protection device 110 of the fourth embodiment, the airbag 120 with the retainer 117 disposed on the inner peripheral surface side is folded and accommodated in the case 112 and the peripheral edge of the inflow opening 122 and the inflator 116 are fixed to the bottom wall portion 113 of the case 112 using the bolt 118 and the nut 119 of the retainer 117, and then the case 112 is attached and fixed to the instrument panel 102 and the lead wire for the operation signal input from the control device (not illustrated) is connected to the inflator 116, in such a manner that it can be mounted on the vehicle 101. Further, when the airbag 120 is fixed to the case 112, the front end 142a of the front-rear tether 142 in the airbag 120 and the front end 148a of the upper-outer tether 148 outside the airbag 120 are also fixed to the bottom wall portion 113 of the case 112 using the bolt 118 of the retainer 117.

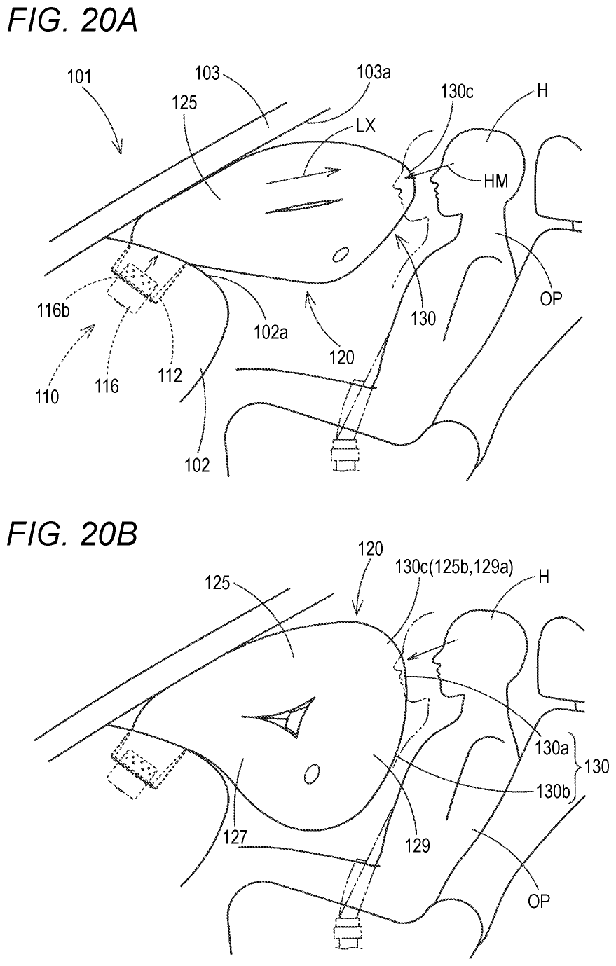

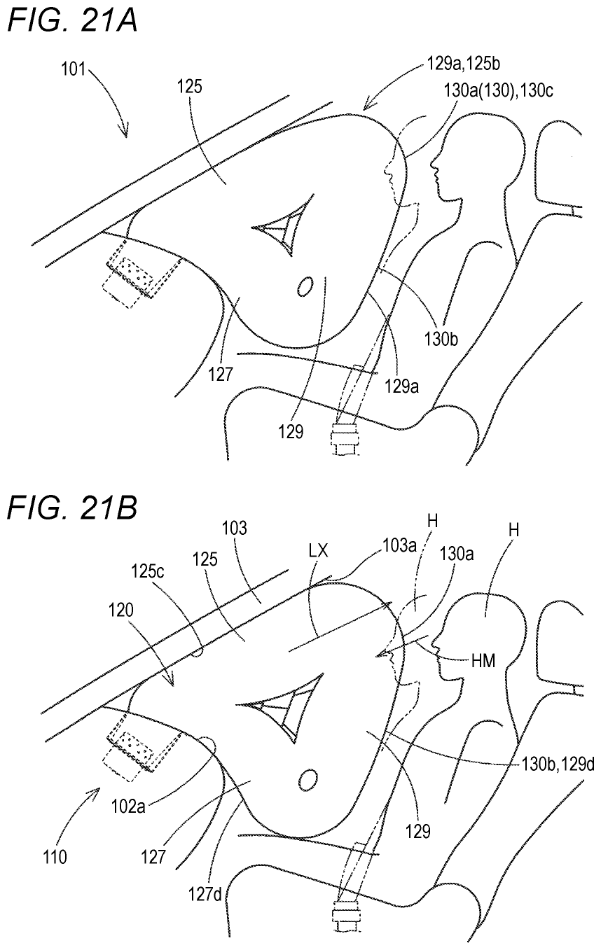

Then, after the occupant protection device 110 is mounted on the vehicle 101, when collision of the vehicle 101 occurs and the control device (not illustrated) detects the collision of the vehicle 101 and operates the inflator 116, the inflator 116 supplies the inflation gas G to the airbag 120, so that the airbag 120 is deployed and inflated rearward from the case 112 as an accommodation part, as illustrated in FIGS. 20A to 21B.

Then, when the airbag 120 completes inflation, the rear inflating portion 129 is disposed in a state where the upper end part 129a is disposed further on a rear side than the lower end part 129b and, if the occupant OP moves forward, as shown by the two-dot chain line in FIG. 13, the vicinity of the head H is received by the head receiving area 130a on the upper side of the receiving area 130 in the rear surface 129d of the rear inflating portion 129 (by the receiving part of the vicinity of the rear end 125b of the upper inflating portion 125 as the second inflating portion). In this case, the rear inflating portion 129 has a shape in which the upper end part 129a side protrudes rearward beyond the lower end part 129b, and thus it is not a behavior that bends and deforms so as to narrow the hollow portion 132, but a behavior that receives the occupant OP as a state (a state where the upper inflating portion 125 compresses the length dimension LU in the front-rear direction) that buckles and deforms the upper inflating portion 125 which extends obliquely upward and rearward from the case 112 as an accommodation part in a substantially columnar shape. Therefore, the airbag 120 which completes the inflation is deformed along with the buckling deformation of the upper inflating portion 125 which can secure a higher reaction force than the bending deformation of the rear inflating portion 129, and thus the airbag 120 can receive the head H of the occupant OP while securing a stable reaction force. In the occupant OP of which the head H is received and who moves forward with reduced kinetic energy, a chest B is received and protected by the chest receiving area 130b on the lower side of the receiving area 130. Needless to say, since the airbag 120 has the hollow portion 132, compared with a case where the entire outer shape is the inflating part, the capacity for the flowing-in amount of the inflation gas G is small, and thus the inflation can be completed quickly.

Therefore, in the occupant protection device 110 of the fourth embodiment, the airbag 120 can complete the inflation quickly, and thus a stable reaction force can be secured when the occupant OP is received.

In the occupant protection device 110 of the fourth embodiment, the upper inflating portion 125 of the airbag 120 is disposed so that the direction LX extending rearward from the case 112 as an accommodation part (extending from the front end 125a toward the rear end 125b when it is inflated) is the direction along the direction opposite to the movement direction HM of the head H of the occupant OP which moves forward when the occupant protection device 110 is operated.

Therefore, in the fourth embodiment, the upper inflating portion 125 of the airbag 120 extends rearward from the case 112 in a direction along the direction opposite to the movement direction HM of the head H of the occupant OP which moves forward when the occupant protection device 110 is operated, and when the head H of the occupant OP is received and it becomes a state of buckling deformation, it is possible to more accurately secure a stable reaction force. Further, in the fourth embodiment, even when the airbag 120 is supposed to receive the head H of the occupant OP immediately before the inflation of the airbag 120 is completed, as illustrated in FIGS. 20A, 20B, and 21A, it is possible to receive the head H of the occupant OP moving forward in the receiving area 130c in the middle of inflation including the vicinity of the upper end 129a of the rear inflating portion 129 near the rear end 125b of the upper inflating portion 125. Thus, even during the initial restraining by the airbag 120, a certain reaction force can be secured and the initial restraining performance of the airbag 120 can be improved.

In the occupant protection device 110 of the fourth embodiment, the airbag 120 is configured so that, when the inflation is completed in a state where the airbag 120 is mounted on the vehicle, the length dimension LU in the front-rear direction from the front end part 125a intersecting the lower inflating portion 127 to the rear end part 125b intersecting the rear inflating portion 129 in the upper inflating portion 125 in a state of protruding from the case 112 as an accommodation part is set to be shorter than the sum of the length dimension LD in the front-rear direction from the front end part 127a intersecting the upper inflating portion 125 to the rear end part 127b intersecting the rear inflating portion 129 in the lower inflating portion 127 and the length dimension LB in the up-down direction from the upper end part 129a intersecting the upper inflating portion 125 to the lower end part 129b intersecting the lower inflating portion 127 in the rear inflating portion 129 and set to be longer than the length dimension LD of the lower inflating portion 127 in the front-rear direction.

Therefore, in the fourth embodiment, when the airbag 120 is inflated, the upper inflating portion 125, the lower inflating portion 127, and the rear inflating portion 129 each have a substantially columnar shape and complete inflation in a substantially triangular annular shape. In this case, the lower inflating portion 127 is inflated to extend downward and rearward along the upper surface 102a side of the instrument panel 102 with the length dimension LD shorter than the upper inflating portion 125 extending obliquely upward and rearward from the case 112. Further, although the length dimension LU of the upper inflating portion 125 is longer than the length dimension LD of the lower inflating portion 127, it is smaller than the total length dimension (LD+LB) of the lower inflating portion 127 and the rear inflating portion 129. Therefore, a state (a state where the upper end part 129a is disposed further on the rear side than the lower end part 129b), that is, a state where the head H of the occupant OP who moves forward can be received by the vicinity of the rear end 125b of the upper inflating portion 125 (the end part of the airbag 120) and by the stable reaction force of the behavior that causes the upper inflating portion 125 to buckle and deform, where, in the rear inflating portion 129, the lower end part 129b is stably disposed further on the front side than the upper end part 129a can be secured.

Further, in the occupant protection device 110 of the fourth embodiment, the airbag 120 is provided with the front-rear tether 142 capable of restricting the rearward movement of the rear inflating portion 129, and the third inflating portion, away from the case 112 by connecting the rear inflating portion 129 at the completion of inflation and the case 112 side as an accommodation part.

Therefore, in the fourth embodiment, since the rear inflating portion 129 is restricted by the front-rear tether 142 from being totally or partially rearwardly moved, the substantially triangular annular shape of the airbag 120 at the time of completion of the inflation is stabilized. This can contribute to stabilizing the occupant protection performance (the performance capable of receiving the head H of the occupant OP which moves forward with the stable reaction force of the behavior that causes the upper inflating portion 125 to buckle and deform) of the airbag 120.

Further, in the occupant protection device 110 of the fourth embodiment, the airbag 120 is provided with the up-down tether 144 which connects the upper inflating portion 125, as the second inflating portion, and the lower inflating portion 127, as the first inflating portion, at the time of completion of inflation and restricts the movement of the upper inflating portion 125 and the lower inflating portion 127 in the direction of mutual separation.

Therefore, in the fourth embodiment, by the up-down tether 144, the separation state of the upper inflating portion 125 and the lower inflating portion 127 when the airbag 120 completes inflation can be stabilized, and thus it can contribute to stabilizing the occupant protection performance of the airbag 120 by stabilizing the substantially triangular annular shape of the airbag 120 when inflation is completed.

In addition, in the occupant protection device 110 of the fourth embodiment, the airbag 120 is provided with the upper-outer tether 148 which connects the upper surface 125c side of the upper inflating portion 125 at the time of completion of inflation and the case 112 side as an accommodation part and restricts the downward movement of the upper inflating portion 125 away from the windshield 103.

Therefore, in the fourth embodiment, the airbag 120 at the time of completion of inflation can maintain a state in which the upper surface 125c side of the upper inflating portion 125 is in contact with the lower surface 103a of the windshield 103 by the upper-outer tether 148. Therefore, during occupant restraint including initial restraint, the upper inflating portion 125 is supported by the windshield 103 on the upper surface 125c side, and thus the bending deformation behavior can be suppressed and the behavior of the buckling deformation state can be stabilized. As a result, the airbag 120 can exhibit favorable occupant restraint performance (the performance to receive the head H of the occupant OP which moves forward with a stable reaction force of the behavior that causes the upper inflating portion 125 to buckle and deform) which can secure a stable reaction force.

In the fourth embodiment, the upper-outer tether 148 disposed on the upper surface 125c side of the upper inflating portion 125 is exemplified as the tether disposed on the outer side of the airbag 120 at the time of completion of the inflation. However, a lower-outer tether may be disposed so that the rear end side is connected to the lower surface 127d side of the lower inflating portion 127 and the front end side is connected to the case 112 side as an accommodation part, such that, when the airbag 120 is inflated, the lower surface 127d of the lower inflating portion 127 can be in close contact with the upper surface 102a side of the instrument panel 102.

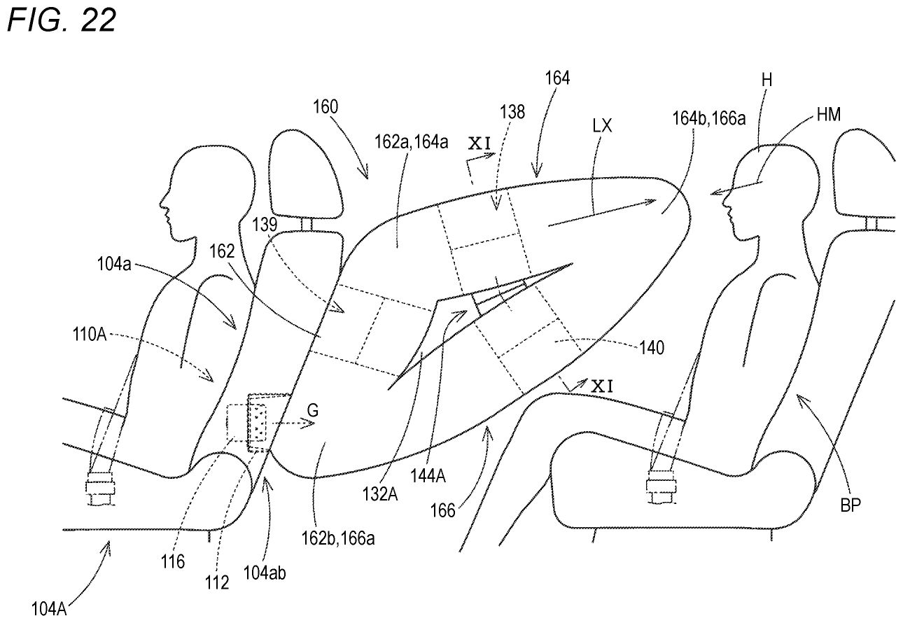

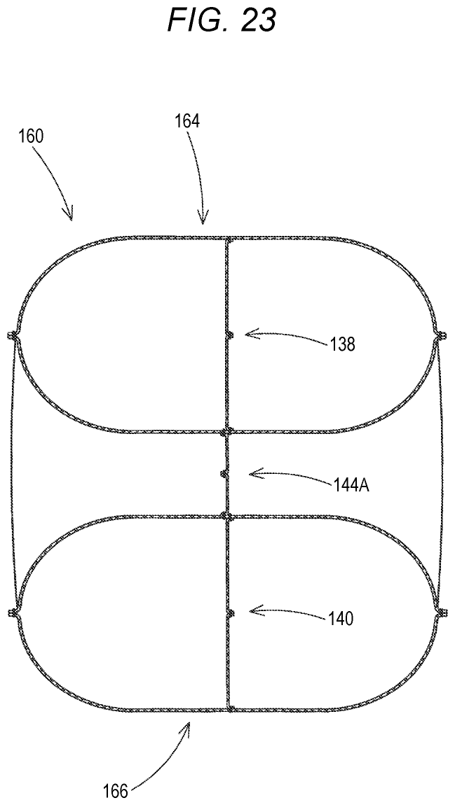

Next, an occupant protection device 110A of a fifth embodiment illustrated in FIGS. 22 and 23 will be described. The occupant protection device 110A uses a head H of an occupant BP of a rear seat as a protection target part of an airbag 160. The occupant protection device 110A has a case 112 as an accommodation part of the airbag 160 disposed on a rear surface 104ab side of a backrest portion 104a in a seat 104A of the front seat as a vehicle body side part on the front side of the seated occupant BP. In addition, the airbag 160 is configured to protrude rearward from the case 112 as an accommodation part when inflated and be inflated so as to be able to receive the occupant BP moving forward and a first inflating portion 162 at the time of completion of the inflation is disposed so as to extend along the rear surface 104ab side of the front seat 104A as the vehicle body side part and to be supported by the rear surface 4ab side of the front seat 104A. Further, a second inflating portion 164 at the completion of inflation extends rearward from the vicinity of an upper end 162a of the first inflating portion 162 and the vicinity of a rear end 164b is disposed as a receiving part for receiving the head H of the occupant BP moving forward.

In other words, as the shape of completion of the inflation, the airbag 160 has a substantially triangular annular shape in which the first inflating portion 162 which extends upward in a substantially columnar shape from the case 112 as the accommodation part along the rear surface 104ab of the seat 104A as the vehicle body side part and is supported by the rear surface 104ab of the seat 104A as the vehicle body side part, the second inflating portion 164 extending in a substantially columnar shape from an end portion (upper end) 162a in the up-down direction of the first inflating portion 162 to the rear side on a protection target part H side of the occupant BP, and a third inflating portion 166 which extends from the rear end 164b of the second inflating portion 164 and intersects the other end portion (lower end) 162b in the up-down direction of the first inflating portion 162 are disposed so as to surround the hollow portion 132. When the inflation is completed, in the airbag 160, the vicinity of the rear end 164b of the second inflating portion 164 is disposed at the rearmost end to serve as a receiving part for the head H as a protection target part of the occupant BP moving forward. Further, when receiving the head H of the occupant BP in the vicinity of the rear end 164b of the second inflating portion 164, the second inflating portion 164 is connected to and supported by an upper end 166a of the third inflating portion 166 so that the vertical movement of the vicinity of the rear end 164b of the second inflating portion 164 is restricted so as to be able to perform compression deformation where the rear end 164b side approaches the front end 164a side along an axial direction LX of the substantially columnar shape of the inflation completion shape. In addition, in a state where the reaction force from the rear surface 104ab of the seat 104A as the vehicle body side part can be secured, the vicinity of the front end 164a of the second inflating portion 164 is connected to the upper end 162a of the first inflating portion 162 so as to abut on the rear surface 104ab of the seat 104A. The cross section of each of the inflating portions 162, 164, and 166 which inflate in a substantially columnar shape has a substantially rectangular shape with rounded left and right edges (see FIG. 23).

Also, in this airbag 160, the second inflating portion 164 is provided so that the direction extending from the front end 164a to the rear end 164b when the inflation is completed is set to a direction along the direction opposite to the movement direction HM of the head H as the protection target part of the occupant BP moving forward when the occupant protection device 110A is operated.

In addition, connecting pieces 138, 139, and 140 for connecting the inner peripheral wall side and the outer peripheral wall side of each of the inflating portions 162, 164, and 166 are disposed, and in order to stabilize the inflation completion shape of the airbag 160 that is a substantially triangular annular shape, an upper-lower tether 144A for connecting the second inflating portion 164 and the third inflating portion 166 is provided to restrict the expansion of the second inflating portion 164 and the third inflating portion 166.

In the occupant protection device 110A of the fifth embodiment, when the airbag 160 completes the inflation, the vicinity of the rear end 164b of the second inflating portion 164 is used as the receiving part of the head H of the occupant BP, and when the occupant BP moves forward, the head H as the protection target part of the occupant BP is received in the vicinity of the rear end 164b of the second inflating portion 164 as the receiving part. In this case, the second inflating portion 164 is supported by the third inflating portion 166 so that the vertical movement is restricted in the vicinity of the rear end 164b of the second inflating portion 164 so as to perform compression deformation where the rear end 164b side approaches the front end 164a side along the axial direction LX of the substantially columnar shape of the inflation completion shape. In addition, in a state where a reaction force from the seat 104A as the vehicle body side part can be secured, the vicinity of the front end 164a of the second inflating portion 164 is connected to the first inflating portion 162 so as to abut on the rear surface 104ab of the seat 104A. Therefore, as a buckling deformation state, in other words, as a compression deformation state (a state where the second inflating portion 164 is compressed in the length dimension in the front-rear direction) in which the rear end 164b side approaches the front end 164a side along the axial direction LX of the substantially columnar shape of the inflation completion shape, the second inflating portion 164 behaves to receive the head H as the protection target part of the occupant BP. That is, since the airbag 160 which completes the inflation is deformed with compression deformation such as buckling deformation of the second inflating portion 164 that can ensure a high reaction force, not bending deformation, it is possible to stably secure reaction force above a predetermined level and receive the head H as the protection target part of the occupant BP. Needless to say, since the airbag 160 is provided with the hollow portion 132, it has less capacity to flow the inflation gas G compared to a case where the entire outer shape of the airbag is used as an inflated portion, and thus the inflation can be completed quickly.

Therefore, even in the occupant protection device 110A of the fifth embodiment, the airbag 160 can complete the inflation quickly and a stable reaction force can be secured when the occupant BP is received.

Also, in the occupant protection device 110A of the fifth embodiment, in the airbag 160 which completes inflation, the rear end 164b moves forward after receiving the head H of the occupant BP in the vicinity of the rear end 164b of the second inflating portion 164 and an area extending from the vicinity of the upper end 66a to the lower end 166b side in the third inflating portion 166 can receive the vicinity of a chest B of the occupant BP. As a result, the occupant BP can be suitably received and protected.

Further, in the occupant protection device 110A of the fifth embodiment, the case 112 as an accommodation part is disposed on the lower end 162b side in the first inflating portion 162 of the airbag 160. However, it may be configured so that the case 112 as an accommodation part is disposed in the upper end 162a side in the first inflating portion 162 of the airbag 160.

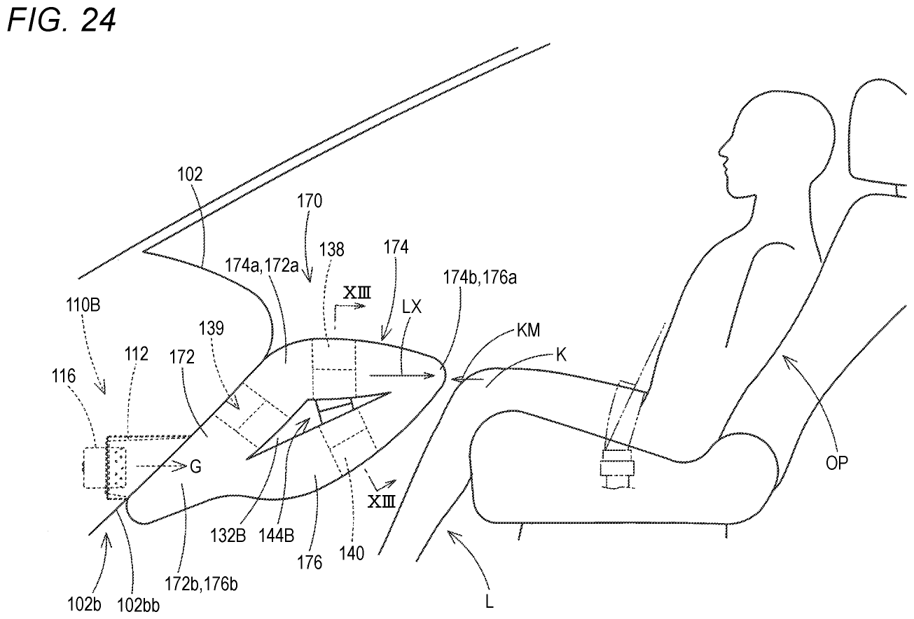

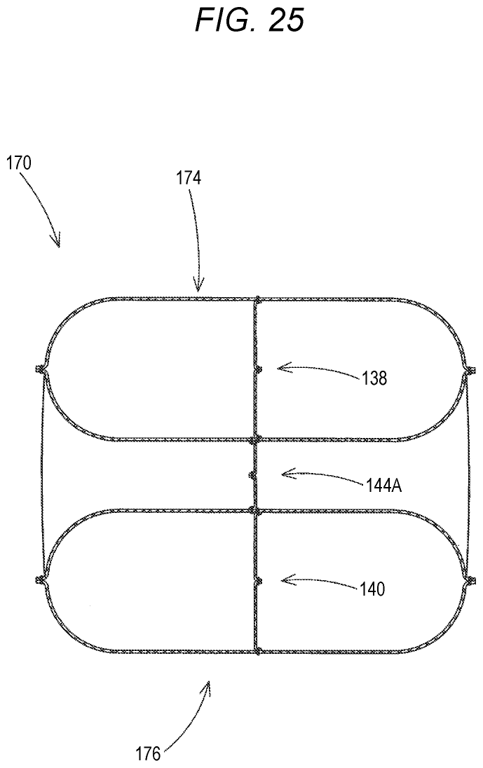

Next, an occupant protection device 110B of a sixth embodiment illustrated in FIGS. 24 and 25 will be described. The occupant protection device 110B uses a knee K of an occupant OP as a protection target part. In the occupant protection device 110B, a case 112 as an accommodation part of an airbag 170 is disposed on a rear surface 102bb side of a lower portion 102b of an instrument panel 102 as a vehicle body side part on the front side of a lower limb L of the seated occupant OP. In addition, the airbag 170 is configured to protrude rearward from the case 112 as an accommodation part when inflated and be inflated so as to be able to receive the knee K of the occupant OP moving forward and a first inflating portion 172 at the time of completion of the inflation is disposed so as to extend along the rear surface 102bb side of the lower portion 102b of the instrument panel 102 as the vehicle body side part and to be supported by the rear surface 102bb side of the instrument panel lower portion 102b. Further, a second inflating portion 174 at the completion of inflation is disposed to extend rearward from the vicinity of a upper end 172a of the first inflating portion 172 and the vicinity of a rear end 174b is disposed as a receiving part for receiving the knee K of the occupant BP moving forward.

In other words, as the shape of completion of the inflation, the airbag 170 has a substantially triangular annular shape in which the first inflating portion 172 which extends upward in a substantially columnar shape from the case 112 as the accommodation part along the rear surface 102bb of the instrument panel lower portion 102b as the vehicle body side part and is supported by the rear surface 102bb of the instrument panel lower portion 102b as the vehicle body side part, the second inflating portion 174 extending in a substantially columnar shape from an end portion (upper end) 172a in the up-down direction of the first inflating portion 172 to the rear side on a protection target part K side of the occupant OP, and a third inflating portion 176 which extends from the rear end 174b of the second inflating portion 174 and intersects the other end portion (lower end) 172b in the up-down direction of the first inflating portion 172 are disposed so as to surround a hollow portion 132. When the inflation is completed, in the airbag 170, the vicinity of the rear end 174b of the second inflating portion 174 is disposed at the rearmost end to serve as a receiving part for the knee K as a protection target part of the occupant OP moving forward. Further, when receiving the knee K of the occupant OP in the vicinity of the rear end 174b of the second inflating portion 174, the second inflating portion 174 is connected to and supported by an upper end 176a of the third inflating portion 176 so that the vertical movement of the vicinity of the rear end 174b of the second inflating portion 164 is restricted so as to be able to perform compression deformation where the rear end 174b side approaches the front end 174a side along an axial direction LX of the substantially columnar shape of the inflation completion shape. In addition, in a state where the reaction force from the rear surface 102bb of the instrument panel lower portion 102b as the vehicle body side part can be secured, the vicinity of the front end 174a of the second inflating portion 174 is connected to the upper end 172a of the first inflating portion 172 so as to abut on the rear surface 102bb of the instrument panel lower portion 102b. The cross section of each of the inflating portions 172, 174, and 176 which inflate in a substantially columnar shape has a substantially rectangular shape with rounded left and right edges (see FIG. 25).

Also, in this airbag 170, the second inflating portion 174 is provided so that the direction extending from the front end 174a to the rear end 174b when the inflation is completed is set to a direction along the direction opposite to the movement direction KM of the knee K as the protection target part of the occupant OP moving forward when the occupant protection device 110B is operated.

In addition, connecting pieces 138, 139, and 140 for connecting the inner peripheral wall side and the outer peripheral wall side of each of the inflating portions 172, 174, and 176 are disposed, and in order to stabilize the inflation completion shape of the airbag 170 that is a substantially triangular annular shape, an upper-lower tether 144B for connecting the second inflating portion 174 and the third inflating portion 176 is provided to restrict the expansion of the second inflating portion 174 and the third inflating portion 176.

In the occupant protection device 110B of the sixth embodiment, when the airbag 170 completes the inflation, the vicinity of the rear end 174b of the second inflating portion 174 is used as the receiving part of the knee K of the occupant OP, and when the occupant OP moves forward, the knee K as the protection target part of the occupant OP is received in the vicinity of the rear end 174b of the second inflating portion 174 as the receiving part. In this case, the second inflating portion 174 is supported by the third inflating portion 176 so that the vertical movement is restricted in the vicinity of the rear end 174b of the second inflating portion 174 so as to perform compression deformation where the rear end 174b side approaches the front end 174a side along the axial direction LX of the substantially columnar shape of the inflation completion shape. In addition, in a state where a reaction force from the instrument panel lower portion 102b as the vehicle body side part can be secured, the vicinity of the front end 174a of the second inflating portion 174 is connected to the first inflating portion 172 so as to abut on the rear surface 102bb of the instrument panel lower portion 102b. Therefore, as a buckling deformation state, in other words, as a compression deformation state (a state where the second inflating portion 174 is compressed in the length dimension in the front-rear direction) in which the rear end 174b side approaches the front end 174a side along the axial direction LX of the substantially columnar shape of the inflation completion shape, the second inflating portion 174 behaves to receive the knee K as the protection target part of the occupant OP. As described above, since the airbag 170 which completes the inflation is deformed with compression deformation such as buckling deformation of the second inflating portion 174 that can ensure a high reaction force, not bending deformation, it is possible to stably secure reaction force above a predetermined level and receive the knee K as the protection target part of the occupant OP. Needless to say, since the airbag 170 is provided with the hollow portion 132, it has less capacity to flow the inflation gas G compared to a case where the entire outer shape of the airbag is used as an inflated portion, and thus the inflation can be completed quickly.

Therefore, even in the occupant protection device 110B of the sixth embodiment, the airbag 170 can complete the inflation quickly and a stable reaction force can be secured when the occupant OP is received.

Also, in the occupant protection device 110B of the sixth embodiment, the case 112 as an accommodation part is disposed on the lower end 172b side of the first inflating portion 172 of the airbag 170. However, the case 112 as an accommodation part may be disposed on the upper end 172a side in the first inflating portion 172 of the airbag 170.

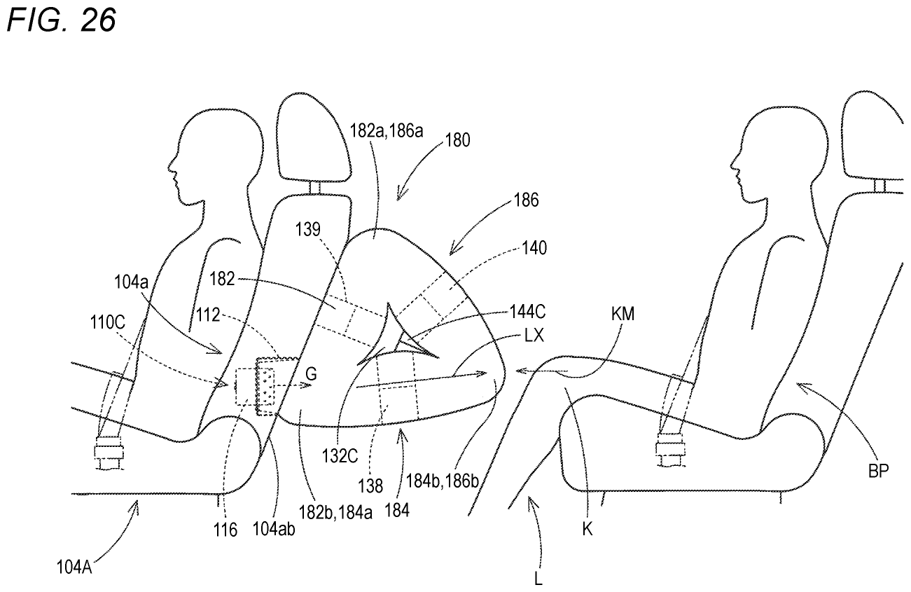

In respective embodiments, the cases where the airbags 120, 160, and 170 are disposed so that the second inflating portions 125, 164, and 714 extend rearward from the upper ends 127a, 162a, and 172a of the first inflating portions 127, 162, and 172 and the rear ends 125b, 164b, and 176b of the second inflating portions 125, 164, and 174 are connected to the upper ends 129a, 166a, and 176a of the third inflating portions 129, 166, and 176, and further the lower ends 129b, 166b, and 176b of the third inflating portion 129, 166, and 176 are connected to the lower ends 127b, 162b, and 172b of the first inflating portion 127, 162, and 172 have been described. However, as an airbag 180 of an occupant protection device 110C of a seventh embodiment illustrated in FIG. 26, the shape at the completion of the inflation may be a substantially triangular annular shape provided with a hollow portion 132C so that a second inflating portion 184 is provided so as to extend rearward in a substantially columnar shape from a front end 184a connected to a lower end 182b of a first inflating portion 182 extending in a substantially columnar shape from a case 112 so as to be supported by a rear surface 104ab of a seat 104A and a third inflating portion 186 extending in a substantially columnar shape connects a lower end 186b to a rear end 184b of the second inflating portion 184 and connects an upper end 186a to an upper end 182a of the first inflating portion 182. The rear end 184b of the second inflating portion 184 is disposed so as to receive a knee K moving forward with the knee K of an occupant BP as the protection target part. A hollow portion 132C is provided with an upper-lower tether 144C which connects the second inflating portion 184 and the third inflating portion 186 so as to stabilize the inflation completion shape of the airbag 180 that is a substantially triangular annular shape.

What is claimed is:

1. An occupant protection device comprising:
an airbag which is folded and accommodated on a front side of a seated occupant in a vehicle and which is deployed and inflated rearward from an accommodation part so that the airbag receives the occupant when inflation gas flows in, the airbag having an inflow opening through which the inflation gas flows in, being disposed so that a peripheral edge of the inflow opening is fixed to the accommodation part, and having an inflation completion shape of a loop shape including an upper portion and a lower portion which branch up and down from the inflow opening side and a rear portion which is a mutual connecting part between rear ends of the upper portion and the lower portion as a confluence part on a tip end side, wherein:
the airbag includes:
a bag main body including the upper portion, the lower portion, and the rear portion; and
a connecting member having flexibility which is disposed between the upper portion and the lower portion and connects the upper portion and the lower portion so as to regulate a separation distance between the upper portion and the lower portion when inflation is completed.

2. The occupant protection device according to claim 1, wherein
the connecting member is disposed so that the separation distance between the upper portion and the lower portion is adjusted to at least two long and short types of a first distance and a second distance longer than the first distance.

3. The occupant protection device according to claim 2, wherein:
the connecting member is connected to a length adjusting unit which adjusts the separation distance between the upper portion and the lower portion to the first distance and the second distance longer than the first distance;
adjustment of the first distance and the second distance in the length adjusting unit is controlled by a control device; and
based on a signal from an occupant detecting unit which detects whether an occupant to be received by the bag main body is a large size occupant or a small size occupant, when the occupant to be received is detected as a large size occupant, the control device adjusts the length adjusting unit so that the separation distance between the upper portion and the lower portion becomes the first distance, and when the occupant to be received is detected as a small size occupant, the control device adjusts the length adjusting unit so that the separation distance between the upper portion and the lower portion becomes the second distance.

4. The occupant protection device according to claim 3, further comprising:
a seat belt device which is provided with a pretensioner mechanism and a force limiter mechanism for restraining an occupant seated on a seat, the seat belt device adjusting a tensile force of a belt which restrains the occupant in at least two low and high stages during operation, wherein:
the control device controls an operation of an inflator which supplies inflation gas to the airbag at the time of a vehicle collision, controls adjustment of the length adjusting unit during operation and adjustment of a tensile force of the seat belt device, and is configured to detect whether a speed of the vehicle is a high speed or a low or moderate speed; and
when the control device controls the inflator to operate,
when the occupant seated on the seat is detected as a large size occupant by the occupant detecting unit, the length adjusting unit is adjusted so that the separation distance between the upper portion and the lower portion becomes the first distance, and further at the speed of the vehicle, when it is detected as a high speed, the tensile force of the belt is adjusted to a high tensile force, and when it is detected as a low or moderate speed, the tensile force of the belt is adjusted to a low tensile force, or
when the occupant seated on the seat is detected as a small size occupant by the occupant detecting unit, the length adjusting unit is adjusted so that the separation distance between the upper portion and the lower portion becomes the second distance, and further at the speed of the vehicle, when it is detected as a high speed, the tensile force of the belt is adjusted to a high tensile force, and when it is detected as a low or moderate speed, the tensile force of the belt is adjusted to a low tensile force.

5. An occupant protection device comprising:
an airbag having a loop shape which is accommodated in an accommodation part disposed in a vehicle body side part on a front side of a seated occupant, protrudes rearward from the accommodation part when inflation gas flows in, is inflated to receive the occupant moving forward, and is provided with a hollow portion in which inflation gas does not flow in a vicinity of a center of an inflating part, wherein:
as the shape at the time of completion of inflation, the airbag has a substantially triangular annular shape in which a first inflating portion extending in a substantially columnar shape from the accommodation part so as to extend along the vehicle body side part and supported by the vehicle body side part, a second inflating portion extending in a substantially columnar shape from an end portion in an up-down direction of the first inflating portion to a rear side on a protection target part side of the occupant, and a third inflating portion which extends from a rear end of the second inflating portion and intersects the other end portion in the up-down direction of the first inflating portion are disposed so as to surround the hollow portion;
when the inflation is completed, in the airbag, a vicinity of the rear end of the second inflating portion is disposed at the rearmost end to serve as a receiving part for a protection target part of the occupant moving forward; and
when the protection target part of the occupant is received in the vicinity of the rear end of the second inflating portion, a vicinity of the rear end of the second inflating portion is supported by the third inflating portion so as to allow the second inflating portion to perform compression deformation where the rear end side approaches a front end side along an axial direction of a substantially columnar shape of the inflation completion shape and a vicinity of the front end of the second inflating portion is connected to the first inflating portion so as to ensure a reaction force from the vehicle body side part.

6. The occupant protection device according to claim 5, wherein
the second inflating portion of the airbag is disposed so that a direction extending from the front end to the rear end when the inflation is completed is set to a direction along a direction opposite to a movement direction of the protection target part of the occupant moving forward when the occupant protection device is operated.

7. The occupant protection device according to claim 5, wherein:
the accommodation part for the airbag is disposed on a rear surface side of a front seat as the vehicle body side part on a front side of a seated occupant;
when the airbag is inflated, the airbag is configured to protrude rearward from the accommodation part and be inflated so as to receive the occupant moving forward;
the first inflating portion at the time of completion of inflation is disposed so as to extend along a rear surface side of the front seat as the vehicle body side part and to be supported by the rear surface side of the front seat; and
the second inflating portion at the time of completion of inflation extends rearward from a vicinity of the upper end of the first inflating portion and a vicinity of the rear end is disposed as a receiving part for receiving the head of the occupant moving forward.

8. The occupant protection device according to claim 5, wherein:
the accommodation part for the airbag is disposed on a rear surface side of the vehicle body side part on a front side of a lower limb of a seated occupant;
when the airbag is inflated, the airbag is configured to protrude rearward from the accommodation part and be inflated so as to receive the occupant moving forward;
the first inflating portion at the time of completion of inflation is disposed so as to extend along the rear surface side of the vehicle body side part and to be supported by the rear surface side of the vehicle body side part; and
the second inflating portion at the time of completion of inflation extends rearward from a vicinity of the upper end of the first inflating portion and a vicinity of the rear end is disposed as a receiving part for receiving the knee of the occupant moving forward.

9. The occupant protection device according to claim 5, wherein:
the accommodation part for the airbag is disposed on an upper surface side of an instrument panel as the vehicle body side part on a front side of a seated occupant;
when the airbag is inflated, the airbag is configured to protrude rearward from the accommodation part so as to block between the instrument panel and a windshield above the instrument panel and be inflated to receive the occupant moving forward;
the first inflating portion at the time of completion of inflation is disposed to extend rearward and downward from the accommodation part so as to extend along an upper surface of the instrument panel as the vehicle body side part and to be supported by the instrument panel; and
the second inflating portion at the time of completion of inflation extends obliquely upward and rearward from a vicinity of the front end of the first inflating portion and a vicinity of the rear end is disposed as a receiving part for receiving a head of the occupant moving forward.

10. The occupant protection device according to claim 9, wherein
when inflation is completed in a state of being mounted on a vehicle, the airbag is configured so that a length dimension in a front-rear direction from a front end part intersecting the first inflating portion to a rear end part intersecting the third inflating portion in the second inflating portion in a state of protruding from the accommodation part is set to be shorter than the sum of a length dimension from a part of the first inflating portion, which is the part intersects the second inflating portion, to a part of the first inflating portion, which is the part intersects the third inflating portion and a length dimension from an upper end part intersecting the second inflating portion to a lower end part intersecting the first inflating portion in the third inflating portion, and is set to be longer than the length dimension from the part of the first inflating portion, which is the part intersects the second inflating portion, to the part of the first inflating portion, which is the part intersects the third inflating portion.

11. The occupant protection device according to claim 9, wherein
the airbag is provided with a front-rear tether which connects the third inflating portion and the accommodation part side at the time of completion of inflation and restricts a rearward movement of the third inflating portion away from the accommodation part.

12. The occupant protection device according to claim 9, wherein
the airbag is provided with an upper-lower tether which connects the second inflating portion and the first inflating portion at the time of completion of inflation and restricts a movement of the second inflating portion and the first inflating portion in a direction of mutual separation.

13. The occupant protection device according to claim 9, wherein
the airbag is provided with an upper-outer tether which connects an upper surface side of the second inflating portion at the time of completion of inflation and the accommodation part side and restricts a downward movement of the second inflating portion away from the windshield.
